(19) United States
(12) Patent Application Publication
(10) Pub. No.: US 2018/0324751 A1
(43) Pub. Date: Nov. 8, 2018

(54) PAGING TECHNIQUES FOR MULTI-BEAM ACCESS SYSTEMS

(71) Applicant: QUALCOMM Incorporated, San Diego, CA (US)

(72) Inventors: Karl Georg Hampel, Hoboken, NJ (US); Muhammad Nazmul Islam, Edison, NJ (US); Keiichi Kubota, San Diego, CA (US); Aleksandar Damnjanovic, Del Mar, CA (US)

(21) Appl. No.: 15/956,440

(22) Filed: Apr. 18, 2018

Related U.S. Application Data
(60) Provisional application No. 62/501,720, filed on May 4, 2017.

(51) Int. Cl. H04W 68/02; H04W 76/11; H04W 76/18; H04W 76/27

(52) U.S. Cl. CPC H04W 68/02; H04W 76/11; H04W 4/70; H04W 76/27; H04W 76/18

(57) ABSTRACT

Methods, systems, and devices for wireless communication are described. A wireless device may receive a compressed paging message broadcast from a base station, and transmit a connection request in response. The wireless device may include a paging response indication (e.g., indicating the connection request results from a received, false or genuine, paging request) and a wireless device identification (e.g., a UE ID) into the modified connection request. The base station may identify the connection request is in response to a paging broadcast by receiving the paging response indication, and determine if the connection request occurred in response to a false paging alert by comparing the received UE ID to the uncompressed paging request message list. If a match is found, the base station may transmit a connection establishment request. If a match is not found the base station may transmit a connection rejection message to the wireless device.

### CROSS REFERENCES

The present Application for Patent claims priority to U.S. Provisional Patent Application No. 62/501,720 by Hampel, et al., entitled “Paging Techniques For Multi-Beam Access Systems,” filed May 4, 2017, assigned to the assignee hereof.

### BACKGROUND

The following relates generally to wireless communication, and more specifically to improved paging techniques for multi-beam access systems.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

Wireless communication systems may include multi-beam access systems (e.g., such as 5G NR systems using millimeter waves (mmW)), such that broadcast transmissions by a base station may be conducted via a beamsweep. For example, broadcast transmissions may be transmitted along multiple beams, beam directions, beam identifiers (IDs), etc. such that the broadcast transmission may span all or a portion of a coverage area. Applying such a beamsweep to the broadcast of transmissions such as paging messages may therefore lead to high resource utilization, which may degrade system performance. To address high resource utilization, the size of the paging broadcast transmission may be reduced via compression (e.g., via index-based paging). However, such compression may lead to increased false paging alerts for some UEs, for example, where the paging broadcast transmission may be incorrectly interpreted by a UE as directed to that UE. Improved false paging avoidance techniques for such scenarios may thus be desired.

### SUMMARY

The described techniques relate to improved methods, systems, devices, or apparatuses that support improved paging techniques for multi-beam access systems. Generally, the described techniques provide for modified connection request designs (e.g., supporting improved false paging avoidance techniques discussed herein). A base station may broadcast a paging message based on a compressed paging list of intended wireless devices to be paged. A wireless device may receive a paging message (e.g., a paging alert) based on the compressed paging broadcast from the base station, and transmit a connection request in response. The wireless device may include a paging response indication (e.g., indicating the connection request results from a received paging request, whether false or genuine) and a wireless device identification (e.g., a user equipment (UE) identifier (ID)) into the modified connection request. The base station may identify that the connection request is in response to a paging broadcast by receiving the paging response indication, and determine if the connection request occurred in response to a false paging alert by comparing the received UE ID to the uncompressed paging request message list. If a match is found (e.g., between the received UE ID of the connection request and the paging list), the base station may transmit a connection request to establish a connection. In cases where a match is not found (e.g., the paging alert was false or unintended for the wireless device associated with the connection request) the network may reject the connection request (e.g., the base station may transmit a connection rejection message to the wireless device). A method of wireless communication is described.

The method may include receiving a compressed paging alert at a user equipment (UE), transmitting, to a base station, a connection request based at least in part on the received compressed paging alert, wherein the connection request includes a UE identifier and a paging response indication, and receiving a connection response to the connection request based at least in part on the transmitted connection request.

An apparatus for wireless communication is described. The apparatus may include means for receiving a compressed paging alert at a user equipment (UE), means for transmitting, to a base station, a connection request based at least in part on the received compressed paging alert, wherein the connection request includes a UE identifier and a paging response indication, and means for receiving a connection response to the connection request based at least in part on the transmitted connection request.

Another apparatus for wireless communication is described. The apparatus may include a processor, memory in electronic communication with the processor, and instructions stored in the memory. The instructions may be operable to cause the processor to receive a compressed paging alert at a user equipment (UE), transmit, to a base station, a connection request based at least in part on the received compressed paging alert, wherein the connection request includes a UE identifier and a paging response indication, and receive a connection response to the connection request based at least in part on the transmitted connection request.

A non-transitory computer readable medium for wireless communication is described. The non-transitory computer-readable medium may include instructions operable to cause a processor to receive a compressed paging alert at a user equipment (UE), transmit, to a base station, a connection request based at least in part on the received compressed paging alert, wherein the connection request includes a UE identifier and a paging response indication, and receive a connection response to the connection request based at least in part on the transmitted connection request.

Some examples of the method, apparatus, and non-transitory computer-readable medium described above may further include processes, features, means, or instructions for receiving a compression indication that indicates the compressed paging alert may be compressed. Some examples of the method, apparatus, and non-transitory computer-readable medium described above may further include processes, features, means, or instructions for including the paging response indication in the connection request based at least in part on the received compression indication.

Some examples of the method, apparatus, and non-transitory computer-readable medium described above may further include processes, features, means, or instructions for entering an idle mode, suspend mode, or inactive mode based at least in part on the received connection response, wherein the connection response rejects the connection request.

In some examples of the method, apparatus, and non-transitory computer-readable medium described above, the connection response comprises a radio resource control (RRC) connection reject message or an RRC connection release message.

Some examples of the method, apparatus, and non-transitory computer-readable medium described above may further include processes, features, means, or instructions for transmitting a connection setup response message to the base station based at least in part on the received connection response, wherein the connection response accepts the connection request.

In some examples of the method, apparatus, and non-transitory computer-readable medium described above, the connection response comprises a radio resource control (RRC) connection setup message or an RRC connection resume message. In some examples of the method, apparatus, and non-transitory computer-readable medium described above, the connection setup response message comprises an RRC connection setup complete message.

In some examples of the method, apparatus, and non-transitory computer-readable medium described above, the compressed paging alert may be a broadcast paging alert and includes a paging index list.

In some examples of the method, apparatus, and non-transitory computer-readable medium described above, the connection request comprises a radio resource control (RRC) connection request message, or a first message of a random access procedure, or a third message of a random access procedure, or a third message of a random access procedure, or an RRC connection request, or an RRC.

In some examples of the method, apparatus, and non-transitory computer-readable medium described above, the UE identifier comprises a system architecture evolution (SAE) temporary mobile subscriber identity (S-TMSI) or an international mobile subscriber identity (IMSI).

Some examples of the method, apparatus, and non-transitory computer-readable medium described above may further include processes, features, means, or instructions for receiving a UE identification type. Some examples of the method, apparatus, and non-transitory computer-readable medium described above may further include processes, features, means, or instructions for transmitting the connection request including the UE identifier, wherein the UE identifier may be based at least in part on the received UE identification type.

A method of wireless communication is described. The method may include receiving, at a base station, a connection request from a user equipment (UE), the connection request including a UE identifier and a paging response indication, comparing the UE identifier with a paging identifier list, and transmitting a connection response based at least in part on a result of the comparison.

An apparatus for wireless communication is described. The apparatus may include means for receiving, at a base station, a connection request from a user equipment (UE), the connection request including a UE identifier and a paging response indication, means for comparing the UE identifier with a paging identifier list, and means for transmitting a connection response based at least in part on a result of the comparison.

Another apparatus for wireless communication is described. The apparatus may include a processor, memory in electronic communication with the processor, and instructions stored in the memory. The instructions may be operable to cause the processor to receive, at a base station, a connection request from a user equipment (UE), the connection request including a UE identifier and a paging response indication, compare the UE identifier with a paging identifier list, and transmit a connection response based at least in part on a result of the comparison.

A non-transitory computer readable medium for wireless communication is described. The non-transitory computer-readable medium may include instructions operable to cause a processor to receive, at a base station, a connection request from a user equipment (UE), the connection request including a UE identifier and a paging response indication, compare the UE identifier with a paging identifier list, and transmit a connection response based at least in part on a result of the comparison.

Some examples of the method, apparatus, and non-transitory computer-readable medium described above may further include processes, features, means, or instructions for determining that the received UE identifier does not correspond to any entries of the paging identifier list. Some examples of the method, apparatus, and non-transitory computer-readable medium described above may further include processes, features, means, or instructions for transmitting the connection response to the UE based at least in part on the determination, wherein the connection response rejects the connection request.

In some examples of the method, apparatus, and non-transitory computer-readable medium described above, the connection response comprises a radio resource control (RRC) connection reject message or an RRC connection release message.

Some examples of the method, apparatus, and non-transitory computer-readable medium described above may further include processes, features, means, or instructions for determining that the UE identifier matches one or more entries of the paging identifier list. Some examples of the method, apparatus, and non-transitory computer-readable medium described above may further include processes, features, means, or instructions for transmitting the connection response to the UE based at least in part on the determination, wherein the connection response accepts the connection request.

In some examples of the method, apparatus, and non-transitory computer-readable medium described above, the connection response comprises a radio resource control (RRC) connection setup message or an RRC connection resume message.

Some examples of the method, apparatus, and non-transitory computer-readable medium described above may further include processes, features, means, or instructions for determining the paging identifier list, the paging identifier list including one or more UE identifiers. Some examples of the method, apparatus, and non-transitory computer-readable medium described above may further include processes, features, means, or instructions for compiling a paging index list based at least in part on the determined paging identifier list. Some examples of the method, apparatus, and non-transitory computer-readable medium described above may further include processes, features, means, or instructions for broadcasting the paging index list, wherein the connection request may be received based at least in part on the broadcast paging index list.

Some examples of the method, apparatus, and non-transitory computer-readable medium described above may further include processes, features, means, or instructions for broadcasting a compressed paging message, wherein the connection request from the UE may be received in response to the compressed paging message.

In some examples of the method, apparatus, and non-transitory computer-readable medium described above, the compressed paging message comprises a paging index list.

In some examples of the method, apparatus, and non-transitory computer-readable medium described above, the compressed paging message further comprises broadcasting a UE identifier type for one or more UEs of the paging index list.

Some examples of the method, apparatus, and non-transitory computer-readable medium described above may further include processes, features, means, or instructions for transmitting a compression indication that indicates a paging index list was compressed. Some examples of the method, apparatus, and non-transitory computer-readable medium described above may further include processes, features, means, or instructions for broadcasting the paging index list based at least in part on the transmitted compression indication.

In some examples of the method, apparatus, and non-transitory computer-readable medium described above, the received connection request comprises a radio resource control (RRC) connection request message, or a first message of a random access procedure, or a third message of a random access procedure.

In some examples of the method, apparatus, and non-transitory computer-readable medium described above, the UE identifier comprises a system architecture evolution (SAE) temporary mobile subscriber identity (S-TMSI) or an international mobile subscriber identity (IMSI).

### BRIEF DESCRIPTION OF THE DRAWINGS

FIG. 1 illustrates an example of a system for wireless communication that supports improved paging techniques for multi-beam access systems in accordance with aspects of the present disclosure.

FIG. 2 illustrates an example of a wireless communications system that supports improved paging techniques for multi-beam access systems in accordance with aspects of the present disclosure.

FIG. 3 illustrates an example of a process flow that supports improved paging techniques for multi-beam access systems in accordance with aspects of the present disclosure.

FIGS. 4 through 6 show block diagrams of a device that supports improved paging techniques for multi-beam access systems in accordance with aspects of the present disclosure.

FIG. 7 illustrates a block diagram of a system including a UE that supports improved paging techniques for multi-beam access systems in accordance with aspects of the present disclosure.

FIGS. 8 through 10 show block diagrams of a device that supports improved paging techniques for multi-beam access systems in accordance with aspects of the present disclosure.

FIG. 11 illustrates a block diagram of a system including a base station that supports improved paging techniques for multi-beam access systems in accordance with aspects of the present disclosure.

FIGS. 12 through 17 illustrate methods for improved paging techniques for multi-beam access systems in accordance with aspects of the present disclosure.

### DETAILED DESCRIPTION

Wireless communications systems employing multi-beam access (e.g., 5G New Radio (NR) systems using millimeter wave (mmW) transmissions) may broadcast transmissions via beamsweeping (e.g., by a base station). That is, broadcast transmissions may be beamswept or transmitted along multiple beams (e.g., beam directions, beam identifiers (IDs), etc.) such that the broadcast transmission may span all or a portion of the coverage area associated with the base station. As such, broadcast transmissions may be associated with high resource utilization (e.g., from capacity demanding beamsweeping of such transmissions). To reduce resource utilization associated with broadcast transmissions, the size of the broadcast transmission may be reduced via compression. For example, a broadcast paging transmission may be compressed (e.g., using index-based paging) by reducing wireless device identification information (e.g., user equipment (UE) IDs) associated with intended recipients of the paging. Compression techniques may include UE ID hashing, utilization of group IDs, etc., to reduce the size of the paging request to a compressed paging index or paging record. However, such compression may result in false alerts (e.g., false paging identifications) by some wireless devices within the wireless communications system. For example, a paging index (e.g., compressed or truncated UE ID information) associated with intended UEs may resemble ID information associated with unintended UEs, such that unintended UEs may falsely identify the broadcast paging request and attempt to connect to the base station (e.g., which may consume additional resources unnecessarily).

According to techniques described herein, improved false paging avoidance techniques may be realized modification of a connection request design (e.g., where the connection request is sent in response to a received, false or genuine, paging request). A UE may receive a paging alert based on a compressed paging broadcast from a base station. All UEs (e.g., intended and unintended) may assume the paging alert is genuine, and initiate connection establishment via a connection request (e.g., a random access procedure including a radio resource control (RRC) connection request). The UE may include a paging response indication into the connection request, indicating the connection request results from a received, false or genuine, paging request. Upon reception of the paging response indication in the connection request, the network (e.g., base station) may verify the UE is an intended recipient of the paging request prior to proceeding with connection establishment.

To verify UEs associated with received connection requests were indeed intended to be paged, the base station may reference a paging list used to generate the paging index list (e.g., the compressed UE IDs generated for the paging broadcast). That is, UEs that receive a paging alert may include both a paging response indication and a UE ID into the connection request. The base station may identify the connection request is in response to a paging broadcast by receiving the paging response indication, and determine if the connection request occurred in response to a false paging alert by comparing the received UE ID to the paging request message list. If a match is found (e.g., between the received UE ID of the connection request and the paging list), the base station may transmit a connection request to establish a connection. In cases where a match is not found (e.g., the paging alert was false or unintended for the UE associated with the connection request) the network may reject the connection request (e.g., the base station may transmit a connection rejection message to the UE).

Aspects of the disclosure are initially described in the context of a wireless communications system. Process flows implementing techniques described herein are then discussed. Further, aspects of the disclosure are illustrated by and described with reference to apparatus diagrams, system diagrams, and flowcharts that relate to improved paging techniques for multi-beam access systems.

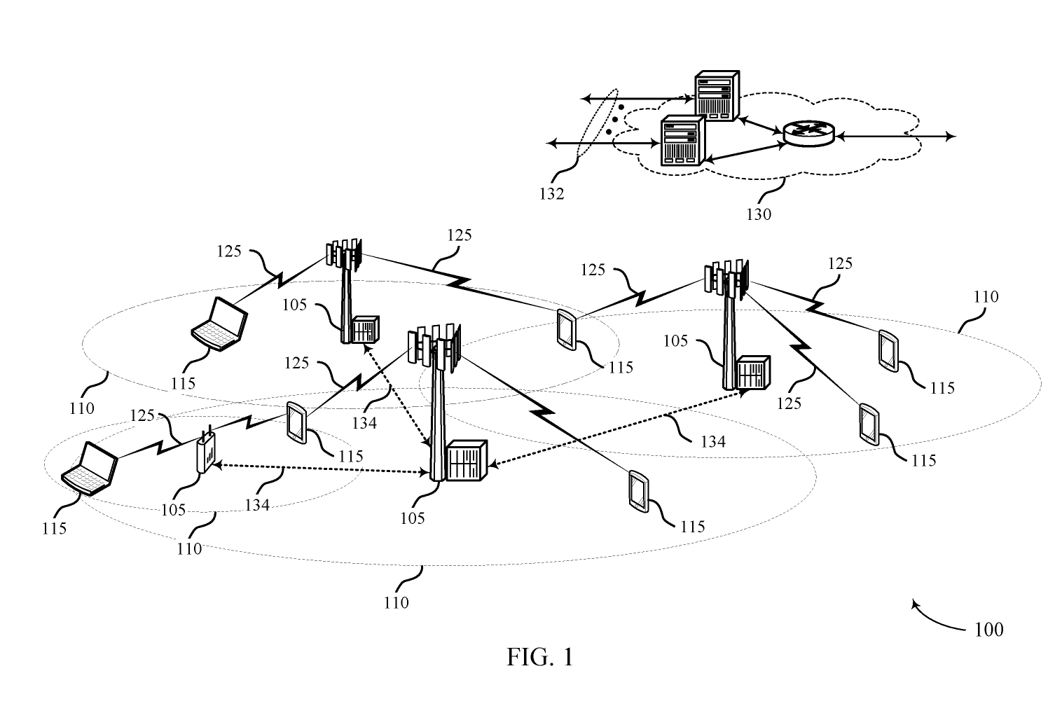

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE), LTE-Advanced (LTE-A) network, or a New Radio (NR) network. In some cases, wireless communications system 100 may support enhanced broadband communications, ultra-reliable (e.g., mission critical) communications, low latency communications, and communications with low-cost and low-complexity devices.

Base stations 105 may wirelessly communicate with UEs 115 via one or more base station antennas. Each base station 105 may provide communication coverage for a respective geographic coverage area 110. Communication links 125 shown in wireless communication system 100 may include uplink transmissions from a UE 115 to a base station 105, or downlink transmissions, from a base station 105 to a UE 115. Control information and data may be multiplexed on an uplink channel or a downlink channel according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a transmission time interval (TTI) of a downlink channel may be distributed between different control regions in a cascaded manner (e.g., between a common control region and one or more UE-specific control regions).

UEs 115 may be dispersed throughout the wireless communication system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of Things (IoT) device, an Internet of Everything (IoE) device, a machine type communication (MTC) device, an appliance, an automobile, or the like.

In some cases, a UE 115 may also be able to communicate directly with other UEs (e.g., using a peer-to-peer (P2P) or device-to-device (D2D) protocol). One or more of a group of UEs 115 utilizing D2D communications may be within the coverage area 110 of a cell. Other UEs 115 in such a group may be outside the coverage area 110 of a cell, or otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out independent of a base station 105.

Some UEs 115, such as MTC or IoT devices, may be low cost or low complexity devices, and may provide for automated communication between machines, i.e., Machine-to-Machine (M2M) communication. M2M or MTC may refer to data communication technologies that allow devices to communicate with one another or a base station 105 without human intervention. For example, M2M or MTC may refer to communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, an MTC device may operate using half-duplex (one-way) communications at a reduced peak rate. MTC devices may also be configured to enter a power saving “deep sleep” mode when not engaging in active communications. In some cases, MTC or IoT devices may be designed to support mission critical functions and wireless communication system 100 may be configured to provide ultra-reliable communications for these functions.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as evolved NodeBs (eNBs) 105.

A base station 105 may be connected by an S1 interface to the core network 130. The core network may be an evolved packet core (EPC), which may include at least one mobility management entity (MME), at least one serving gateway (S-GW), and at least one Packet Data Network (PDN) gateway (P-GW). The MME may be the control node that processes the signaling between the UE 115 and the EPC. All user Internet Protocol (IP) packets may be transferred through the S-GW, which itself may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service.

The core network 130 may provide user authentication, access authorization, tracking, IP connectivity, and other access, routing, or mobility functions. At least some of the network devices, such as base station 105, may include subcomponents such as an access network entity, which may be an example of an access node controller (ANC). Each access network entity may communicate with a number of UEs 115 through a number of other access network transmission entities, each of which may be an example of a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communication system 100 may operate in an ultra-high frequency (UHF) region using frequency bands from 700 MHz to 2600 MHz (2.6 GHz), although some networks (e.g., a wireless local area network (WLAN)) may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communication system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

Thus, wireless communication system 100 may support millimeter wave (mmW) communications between UEs 115 and base stations 105. Devices operating in mmW or EHF bands may have multiple antennas to allow beamforming. That is, a base station 105 may use multiple antennas or antenna arrays to conduct beamforming operations for directional communications with a UE 115. Beamforming (which may also be referred to as spatial filtering or directional transmission) is a signal processing technique that may be used at a transmitter (e.g., a base station 105) to shape and/or steer an overall antenna beam in the direction of a target receiver (e.g., a UE 115). This may be achieved by combining elements in an antenna array in such a way that transmitted signals at particular angles experience constructive interference while others experience destructive interference.

Multiple-input multiple-output (MIMO) wireless systems use a transmission scheme between a transmitter (e.g., a base station 105) and a receiver (e.g., a UE 115), where both transmitter and receiver are equipped with multiple antennas. Some portions of wireless communication system 100 may use beamforming. For example, base station 105 may have an antenna array with a number of rows and columns of antenna ports that the base station 105 may use for beamforming in its communication with UE 115. Signals may be transmitted multiple times in different directions (e.g., each transmission may be beamformed differently). A mmW receiver (e.g., a UE 115) may try multiple beams (e.g., antenna subarrays) while receiving the synchronization signals.

In some cases, the antennas of a base station 105 or UE 115 may be located within one or more antenna arrays, which may support beamforming or MIMO operation. One or more base station antennas or antenna arrays may be collocated at an antenna assembly, such as an antenna tower. In some cases, antennas or antenna arrays associated with a base station 105 may be located in diverse geographic locations. A base station 105 may use multiple antennas or antenna arrays to conduct beamforming operations for directional communications with a UE 115.

In some cases, wireless communication system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use Hybrid ARQ (HARM) to provide retransmission at the MAC layer to improve link efficiency. In the control plane, the Radio Resource Control (RRC) protocol layer may provide establishment, configuration, and maintenance of an RRC connection between a UE 115 and a network device, base station 105, or core network 130 supporting radio bearers for user plane data. At the Physical (PHY) layer, transport channels may be mapped to physical channels.

Time intervals in LTE or NR may be expressed in multiples of a basic time unit (which may be a sampling period of Tₛ= 1/30,720,000 seconds). Time resources may be organized according to radio frames of length of 10 ms (T_{f}=307200Tₛ), which may be identified by a system frame number (SFN) ranging from 0 to 1023. Each frame may include ten 1 ms subframes numbered from 0 to 9. A subframe may be further divided into two 0.5 ms slots, each of which contains 6 or 7 modulation symbol periods (depending on the length of the cyclic prefix prepended to each symbol). Excluding the cyclic prefix, each symbol contains 2048 sample periods. In some cases the subframe may be the smallest scheduling unit, also known as a TTI. In other cases, a TTI may be shorter than a subframe or may be dynamically selected (e.g., in short TTI bursts or in selected component carriers using short TTIs).

A resource element may consist of one symbol period and one subcarrier (e.g., a 15 kHz frequency range). A resource block may contain 12 consecutive subcarriers in the frequency domain and, for a normal cyclic prefix in each OFDM symbol, 7 consecutive OFDM symbols in the time domain (1 slot), or 84 resource elements. The number of bits carried by each resource element may depend on the modulation scheme (the configuration of symbols that may be selected during each symbol period). Thus, the more resource blocks that a UE 115 receives and the higher the modulation scheme, the higher the data rate may be.

Wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

In some cases, wireless communication system 100 may utilize enhanced component carriers (eCCs). An eCC may be characterized by one or more features including: wider bandwidth, shorter symbol duration, shorter TTIs, and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz, etc.) at reduced symbol durations (e.g., 16.67 microseconds). A TTI in eCC may consist of one or multiple symbols. In some cases, the TTI duration (that is, the number of symbols in a TTI) may be variable.

A shared radio frequency spectrum band may be utilized in an NR shared spectrum system. For example, an NR shared spectrum may utilize any combination of licensed, shared, and unlicensed spectrums, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

In some cases, wireless communication system 100 may utilize both licensed and unlicensed radio frequency spectrum bands. For example, wireless communication system 100 may employ LTE License Assisted Access (LTE-LAA) or LTE Unlicensed (LTE U) radio access technology or NR technology in an unlicensed band such as the 5 GHz Industrial, Scientific, and Medical (ISM) band. When operating in unlicensed radio frequency spectrum bands, wireless devices such as base stations 105 and UEs 115 may employ listen-before-talk (LBT) procedures to ensure the channel is clear before transmitting data. In some cases, operations in unlicensed bands may be based on a CA configuration in conjunction with CCs operating in a licensed band. Operations in unlicensed spectrum may include downlink transmissions, uplink transmissions, or both. Duplexing in unlicensed spectrum may be based on frequency division duplexing (FDD), time division duplexing (TDD) or a combination of both.

A UE 115 attempting to access a wireless network may perform an initial cell search by detecting a primary synchronization signal (PSS) from a base station 105. The PSS may enable synchronization of slot timing and may indicate a physical layer identity value. The UE 115 may then receive a secondary synchronization signal (SSS). The SSS may enable radio frame synchronization, and may provide a cell identity value, which may be combined with the physical layer identity value to identify the cell. The SSS may also enable detection of a duplexing mode and a cyclic prefix length. Some systems, such as time division duplex (TDD) systems, may transmit a PSS but not an SSS, or vice versa. Both the PSS and the SSS may be located in the central subcarriers (e.g., 62 and 72 subcarriers) of a carrier, respectively. In some cases, a UE 115 may acquire the synchronization signals by performing a correlation that includes combining a series of cumulative, coherent sub-correlations, where the sub-correlations may involve a comparison between the signal received during each interval and the predefined repeated sequences in the synchronization signal.

After completing initial cell synchronization, the UE 115 may receive a master information block (MIB) and may decode the MIB. The MIB may contain system bandwidth information, a system frame number (SFN), and a physical hybrid automatic repeat request (HARD) indicator channel (PHICH) configuration. The MIB may be transmitted on physical broadcast channel (PBCH) and may utilize the first 4 orthogonal frequency division multiple access (OFDMA) symbols of the second slot of the first subframe of each radio frame. It may use the middle 6 resource blocks (72 subcarriers) in the frequency domain. The MIB carries a few important pieces of information for UE 115 initial access, including: downlink channel bandwidth in term of resource blocks, PHICH configuration (duration and resource assignment), and SFN. A new MIB may be broadcast every fourth radio frame (SFN mod 4=0) and rebroadcast every frame (10 ms). Each repetition is scrambled with a different scrambling code. After reading an MIB (either a new version or a copy), the UE 115 may try different phases of a scrambling code until it gets a successful cyclic redundancy check (CRC). The phase of the scrambling code (0, 1, 2 or 3) may enable the UE 115 to identify which of the four repetitions has been received. Thus, the UE 115 may determine the current SFN by reading the SFN in the decoded transmission and adding the scrambling code phase.

After decoding the MIB, the UE 115 may receive one or more system information block (SIBs). For example, SIB1 may contain cell access parameters and scheduling information for other Ms. Decoding SIB1 may enable the UE 115 to receive SIB2. SIB2 may contain radio resource control (RRC) configuration information related to random access channel (RACH) procedures, paging, physical uplink control channel (PUCCH), physical uplink shared channel (PUSCH), power control, sounding reference signal (SRS), and cell barring. The UE 115 may thus decode SIB1 and SIB2 prior to accessing the network. Different Ms may be defined according to the type of system information conveyed. A new SIB1 may be transmitted in the fifth subframe of every eighth frame (SFN mod 8=0) and rebroadcast every other frame (20 ms). SIB1 includes access information, including cell identity information, and it may indicate whether a UE 115 is allowed to camp on a cell of a base station 105. SIB1 also includes cell selection information (or cell selection parameters). Additionally, SIB1 includes scheduling information for other Ms. SIB2 may be scheduled dynamically according to information in SIB1, and includes access information and parameters related to common and shared channels. The periodicity of SIB2 may be set to 8, 16, 32, 64, 128, 256 or 512 radio frames.

After the UE 115 decodes SIB2, it may transmit a RACH preamble to a base station 105. This may be known as RACH message 1 (e.g., MSG-1). For example, the RACH preamble may be randomly selected from a set of 64 predetermined sequences. This may enable the base station 105 to distinguish between multiple UEs 115 trying to access the system simultaneously. The base station 105 may respond with a random access response (RAR), or RACH message 2 (e.g., MSG-2), that may provide an uplink resource grant, a timing advance and a temporary cell radio network temporary identity (C-RNTI). The UE 115 may then transmit an RRC connection request, or RACH message 3 (e.g., MSG-3), along with a temporary mobile subscriber identity (TMSI) (e.g., if the UE 115 has previously been connected to the same wireless network) or a random identifier. The RRC connection request may also indicate the reason the UE 115 is connecting to the network (e.g., emergency, signaling, data exchange, etc.). The base station 105 may respond to the connection request with a contention resolution message, or RACH message 4 (e.g., MSG-4), addressed to the UE 115, which may provide a new C-RNTI. If the UE 115 receives a contention resolution message with the correct identification, it may proceed with RRC setup. If the UE 115 does not receive a contention resolution message (e.g., if there is a conflict with another UE 115) it may repeat the RACH process by transmitting a new RACH preamble.

Wireless communications system 100 may support modified UE connection request designs (e.g., supporting improved false paging avoidance techniques discussed herein). UEs 115 may receive a paging alert based on compressed paging broadcasts from base stations 105 and transmit a connection request in response. UEs 115 may include a paging response indication (e.g., indicating the connection request results from a received, false or genuine, paging request) and a UE ID into the modified connection request. Base stations 105 may identify the connection request is in response to a paging broadcast by receiving the paging response indication, and determine if the connection request occurred in response to a false paging alert by comparing the received UE ID to the uncompressed paging request message list (e.g., a paging list used to generate compressed paging index list for the paging broadcast.

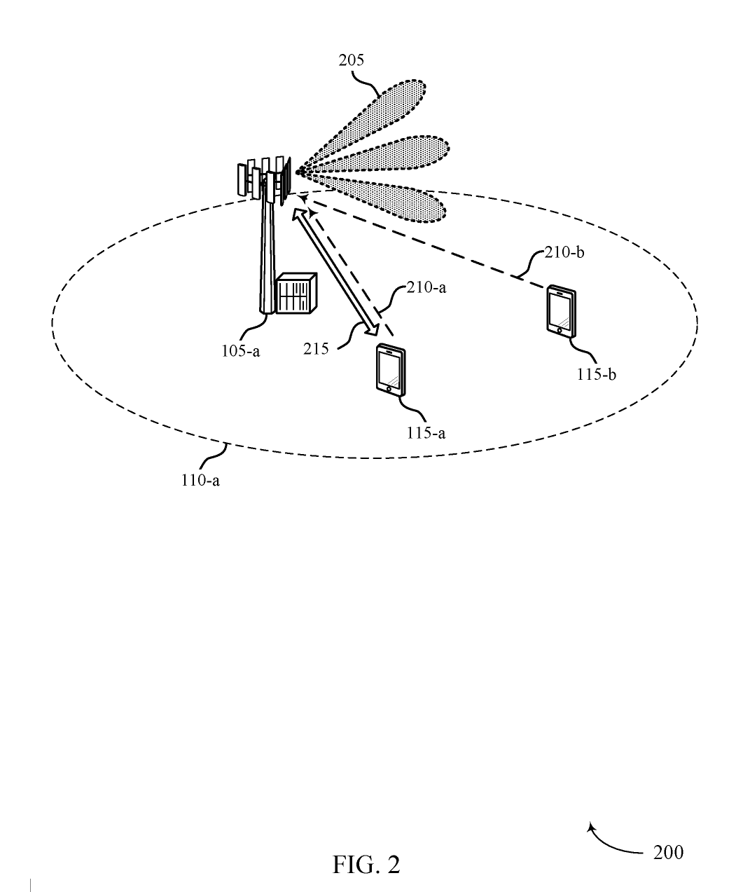

FIG. 2 illustrates an example of a wireless communications system 200 that supports improved paging techniques for multi-beam access systems in accordance with various aspects of the present disclosure. In some examples, wireless communications system 200 may implement aspects of wireless communication system 100. Wireless communications system 200 may include a base station 105-a, a UE 115-a, and a UE 115-b, which may be examples of the corresponding devices described herein. Broadly, wireless communications system 200 illustrates examples of base station 105-a, UE 115-a, and UE 115-b using conditional connection establishment in wireless systems supporting index based paging (e.g., multi-beam wireless communications systems employing beamsweeping of one or more paging messages). That is, base station 105-a may conditionally establish connection with a UE 115 based on whether or not the UE 115 was the intended recipient of the paging message, according to techniques described herein.

Wireless communications system 200 may resemble a multi-beam access system (e.g., 5G NR system using mmW transmissions) where broadcast transmissions (e.g., from base station 105-a) may be conducted via beamsweeping. That is, broadcast transmissions may be transmitted along multiple beams 205 (e.g., beam directions, beam identifiers (IDs), etc.) such that the broadcast transmission may span all or a portion of the coverage area 110-a. As such broadcast transmissions may be associated with costly resource utilization, as transmissions may use resources over several beams 205 to beamsweep the broadcast transmission throughout the coverage area 110-a. For example, radio resource overhead for a paging transmission may increase with the number of beams used for transmission. The radio resource overhead may also be higher for narrower bandwidths compared to wider bandwidths. For example the radio resource overhead may be higher for a 20 MHz bandwidth than for a 100 MHz. In some cases, the radio resource overhead in broadcasting paging transmissions may be reduced by reducing the size of the paging transmission (e.g., compressing a paging message).

UEs 115 may receive a compressed paging alert broadcast from base station 105-a (e.g., via beams 205), and transmit a connection request 210 in response (e.g., a radio resource control (RRC) connection request message, or an RRC connection resume request message, or an RRC connection reactivation request message, or a first message of a random access procedure, or a third message of a random access procedure. In some examples UEs 115 may receive the compressed paging alert broadcast while in an RRC idle mode or a controlled inactive state. UEs 115 may include a paging response indication (e.g., indicating the connection request results from a received, false or genuine, paging request) and a wireless device identification (e.g., a UE ID) into the connection request 210. Base station 105-a may identify a connection request 210 is in response to a paging broadcast by receiving the paging response indication, and determine if the connection request 210 occurred in response to a false paging alert by comparing the received UE ID to the uncompressed paging request message list. If a match is found, base station 105-a may transmit a connection establishment request (e.g., an RRC connection setup message or an RRC connection resume message), and establish a connection 215 with the UE 115. If a match is not found the base station 105-a may transmit a connection rejection message (e.g., an RRC connection reject message or an RRC connection release message) to the UE 115. As illustrated in the present example, UE 115-a may be an intended recipient of a paging request and UE 115-b may be an unintended recipient of a paging request. As such, UE 115-a may transmit connection request 210-a in response, and UE 115-b may transmit connection request 210-b in response. After receiving the connection requests, base station 105-a may transmit a connection rejection message to UE 115-b, and may establish a connection 215 with UE 115-a according to techniques described herein, as discussed in more detail below.

To reduce resource utilization associated with broadcast transmissions, the size of the broadcast transmission may be reduced via compression. For example, a broadcast paging transmission may be compressed (e.g., index based paging) by reducing wireless device identification information associated with intended recipients of the paging. Such compression may refer to a hash applied to identifications (e.g., UE IDs) of intended recipient UEs 115 (e.g., UE 115-a) that are included in the broadcast paging request. UE IDs may include a system architecture evolution (SAE) temporary mobile subscriber identity (S-TMSI), an international mobile subscriber identity (IMSI), etc. In some cases, the compression may be based on a truncation of such UE IDs. In other cases, the compression may be based on replacing the UE ID with a group ID (e.g., assuming the UE 115 has been previously associated with one or more group IDs). Other forms of compression may also be employed to reduce the size of (e.g., resources associated with) the broadcast paging request. Compressed UE IDs may be referred to as a paging index or a paging record.

However, such compression of UE identification information may result in false alerts (e.g., false paging identifications) at some UEs 115 within the wireless communications system. For example, compression of identification information for UE 115-a (e.g., an intended recipient of the broadcast paging request) may result in a false paging alert identified by UE 115-b (e.g., an unintended recipient of the broadcast paging request). For example, a paging index (e.g., compressed or truncated ID information) associated with UE 115-a may resemble ID information associated with UE 115-b, such that UE 115-b may falsely identify the broadcast paging request and attempt to connect to base station 105-a (e.g., which may consume additional resources unnecessarily). Therefore, base station 105-a may broadcast a paging message containing a list of UE IDs (e.g., compressed indexes). UEs 115 may evaluate the paging message, compare UE IDs (or indexes) of the paging message to its own UE ID (or index), and gets alerted in case it finds a match (e.g., identifies a paging alert). Upon this paging alert, UEs 115 may attempt to establish a connection to base station 105-a to retrieve the data waiting for it on the network. If a UE 115 does not find a match, the UE 115 will not identify a paging alert, and may reenter an idle mode or sleep mode or suspend mode or inactive mode.

In some cases, compression may be conducted in a lossless manner. In such cases, each paging index may be unambiguously mapped to a UE ID. However, to achieve increased savings in resource overhead for broadcast of transmissions such as paging messages, compression may be conducted such that losses are incurred. Such losses may result in false paging alerts, as compressed paging messages may map to multiple UE IDs (e.g., among which only a subset may be intended to be paged by a base station). In some cases, the larger the compression, the higher the fail rate (e.g., the higher the occurrence of false alerts of paging requests identified by unintended UEs). As such, compression (e.g., compression rates) may be configured as a design parameter for different wireless communications systems, depending on system needs (e.g., connection latency requirements, resource overhead requirements, etc.). For example, the overhead associated with unsuccessful connection establishment attempts (e.g., false paging alerts) may be correlated with false paging alert probability. As such, resulting overhead in wireless communications systems may be adjusted based on the degree of compression applied to broadcast paging messages.

In some cases, upon receiving a paging index (e.g., from broadcast paging) a UE 115 may verify if the paging alert is genuine (e.g., verify if the paging message was targeted for or intended for the UE 115). Verification by the UE 115 may use additional resources (e.g., signaling). Alternatively, techniques described herein may allow for false alert resolution built into connection requests from UEs 115 that receive a matched paging index, with no additional signaling used to verify if the paging alert is genuine. Procedures described herein may not use additional signaling messages to verify genuine alerts, and may use reduced (e.g., minimal) additional overhead for false alerts (e.g., for connection rejection messages from a base station 105-a to a UE 115-b).

For example, UE 115-a and UE 115-b may receive paging alerts from base station 105-a via a paging broadcast. Both UE 115-a and UE 115-b may assume the alerts are genuine and proceed to attempt to establish connections with base station 105-a (e.g., to receive data waiting on the network) via connection requests 210 (e.g., RRC connection requests). In some cases, connection establishment may include a random access procedure followed by an RRC connection request. As UE 115-a and UE 115-b may include their associated UE IDs in their respective connection requests 210, the network or a component of the network (e.g., base station 105-a) may verify if UE IDs associated with UE 115-a and UE 115-b match an entry on the paging list (e.g., a list used by base station 105-a to generate compressed IDs used in the paging request). If a received UE ID matches a UE ID of the paging list, the network may accept the connection request (e.g., via an RRC connection setup message). That is, if the UE ID associated with UE 115-a included in the connection request 210-a matches an intended UE ID of a paging list at base station 105-a, base station 105-a may transmit a connection response to the connection request to establish a connection 215. In such a case, no additional signaling may be used for verification, and the connection establishment may commence.

As an example, wireless communications system 200 may illustrate a scenario where UE 115-a is an intended recipient of a paging request broadcast by base station 105-a, and where UE 115-b is an unintended recipient of a paging request broadcast by base station 105-a. Upon receiving a false alert, UE 115-b may transmit a connection request 210-b to base station 105-a. Base station 105-a may compare a UE 115-b ID received in the connection request 210-b with a paging list, and may determine the UE 115-b was not an intended recipient of the paging message. The base station 105-a may then reject the connection request (e.g., via an RRC connection reject message, an RRC release message, etc.). In some cases, the rejection of the connection request may include a cause or purpose indication such as, for example, false alert to paging, to indicate to the UE 115-b the received paging request was a false alert. Upon receiving a genuine alert, UE 115-a may transmit a connection request 210-a to base station 105-a. Base station 105-a may compare a UE 115-a ID received in the connection request 210-a with a paging list, and may determine the UE 115-a was an intended recipient of the paging message, and proceed with the connection procedure (e.g., transmit RRC connection message).

The network may apply such techniques (e.g., UE ID and paging list matching) for connection establishment attempts that occur in response to paging broadcasts. To distinguish paging based connection establishment attempts from other types of connection establishment attempts (e.g., UE initiated attempts), UEs 115 may include a paging response indication when requesting connection establishment (e.g., paging response indications may be included in connection requests 210). This indication may, for example, be included in the RRC connection request, MSG-1 or MSG-3 of the random access procedure (e.g., a random access preamble, etc.). In some cases, the network may apply the paging list matching procedure if the paging response indication is included in the connection request. In some cases, the network may not apply the paging list matching procedure if the paging response indication is not included in the connection request 210. As such, intentional connection establishment procedures may be pursued successfully. In some cases, the indication may be included as an additional information element (IE) in the message (e.g., connection request 210), the paging response indication may be captured in a form of a specific entry for a cause IE already provided for the message, etc.

The matching procedure may further be omitted if paging message compression is not applied. In such cases, the network may, for example, include a compression indication in the paging broadcast. Additionally or alternatively, the compression indication may be included as a system information message. Such information may allow UEs 115 to limit or restrict the inclusion of the paging response indication (e.g., in the connection request of the connection establishment procedure) to occasions where the paging request messages are compressed. The network may further avoid the matching operation (e.g., the paging list matching procedure) in cases where base station 105-a has not transmitted a compression indication.

The network may support paging for different UE ID types (e.g., types of UE IDs such as IMSI, S-TMSI, 5G globally unique temporary identifier (5G-GUTI), 5G S-temporary mobile subscription identifier (5G-S-TMSI), permanent equipment identifier (PEI), public UE identifier (PUI), subscription concealed identifier (SUCI), or subscription permanent identifier (SUPI), etc.). For example, in some wireless communications systems (e.g., LTE networks), UE 115-a and UE 115-b may be paged with respect to their IMSI or S-TMSI. In some cases, more than two UE ID types may be supported. If UE IDs of each paging record carry their own type, the information broadcast for each paging record (e.g., UE ID) may also include the associated UE ID type. The UE ID type may be included with the paging index into the broadcast. Alternatively, different types of paging broadcast mechanisms may be provided (e.g., via different paging channels), which may allow the UE 115 to derive the UE ID type referred to by the paging index. Further, all UE IDs of each type may be bundled, compressed, and broadcast together with a UE ID type indicator.

The UE 115 may evaluate the paging index received via broadcast with respect to the corresponding UE ID type. In case the UE 115 is alerted and accesses the network, the UE 115 may include the UE ID pertaining to the UE ID type indicated in the paging broadcast. This may allow the base station 105-a to match the UE ID received (e.g., in the connection request) with the IDs held on the paging record list.

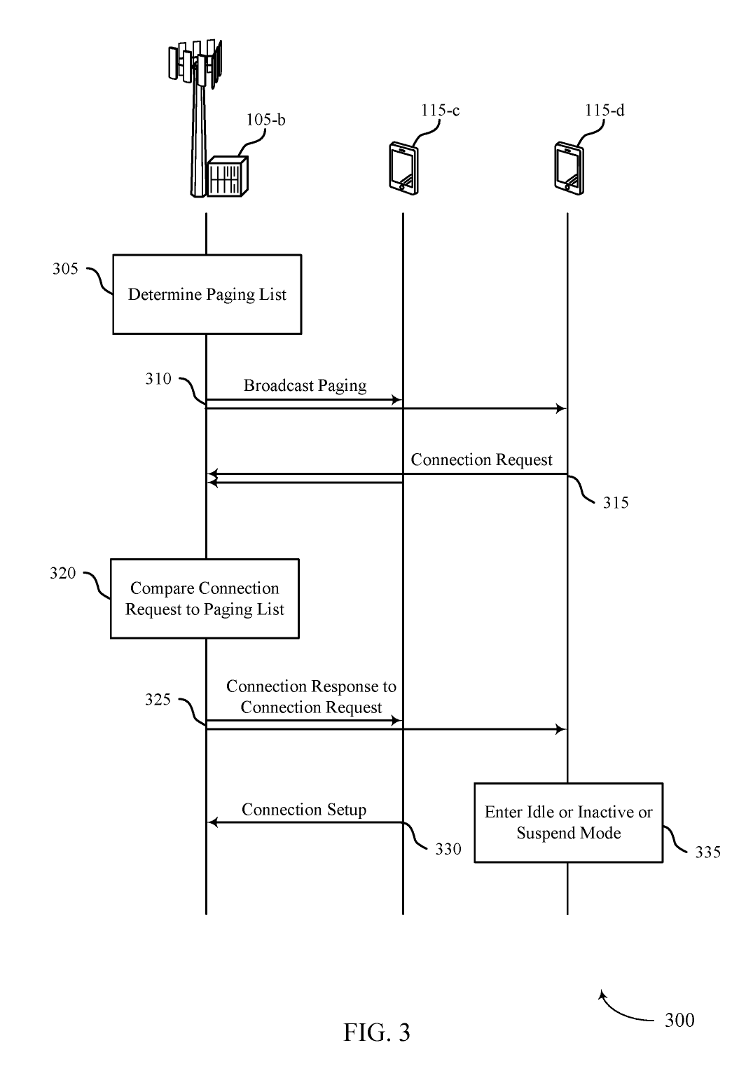

FIG. 3 illustrates an example of a process flow 300 that supports improved paging techniques for multi-beam access systems in accordance with various aspects of the present disclosure. In some examples, process flow 300 may implement aspects of wireless communications system 100 and/or wireless communications system 200, as described herein. Process flow 300 may include a base station 105-b, a UE 115-c, and a UE 115-d, which may be examples of the corresponding devices described herein. Broadly, process flow 300 may illustrate techniques associated with broadcasting paging messages, where UE 115-c is an intended recipient and UE 115-d is an unintended recipient (e.g., receives a false paging indication from the broadcast paging messages). As such, UE 115-c may be an example of UE 115-a, and UE 115-d may be an example of UE 115-b, as described with reference to FIG. 2.

At step 305, base station 105-b may determine a paging list. In some cases, the paging list may refer to a paging identifier list or an uncompressed paging list. The base station 105-b may, in some cases, compile a paging index list based on a compression of the paging list. In some cases, the paging index list (e.g., containing UE indexes or compressed UE IDs) may refer to a compressed paging identifier list.

At step 310, base station 105-b may broadcast the paging index list to UE 115-c and UE 115-d. In some cases, such a broadcast may refer to a compressed paging broadcast. In some cases, base station 105-b may additionally transmit a compression indication, indicating the paging index list is compressed.

At step 315, UE 115-c and UE 115-d may transmit a connection request to base station 105-b based on a received paging alert (e.g., based on matching their UE IDs with a compressed ID of the compressed paging message). Each connection request may include a UE ID and a paging response indication (e.g., indicating the connection request is in response to a received paging alert). In some cases, the UE ID may refer to a S-TMSI, an IMSI, a 5G-GUTI, a 5G-S-TMSI, a PEI, a PUI, a SUCI, or a SUPI.

At step 320, base station 105-b may compare the UE IDs included in the received connection requests with a paging list (e.g., an uncompressed paging identifier list). Such a comparison may be used to determine whether or not UE 115-c and UE 115-d received genuine or false paging alerts (e.g., if base station 105-b did indeed intend to page UE 115-c and UE 115-d).

At step 325, base station 105-b may transmit a connection response to UE 115-c and UE 115-d. The connection response may be based on the received connection request, as well as the comparison discussed in step 320. In the present example, UE 115-c may be an intended UE for paging, and UE 115-d may be an unintended UE for paging. As such, the connection response to UE 115-c may include a connection response that accepts the connection request (e.g., an RRC connection setup message or an RRC connection resume message). Further, the connection response to UE 115-d may include a connection response that rejects the connection request (e.g., an RRC connection reject message or an RRC connection release message).

At step 330, UE 115-c may transmit a connection setup message in response to the received connection response that accepts the connection request.

At step 335, UE 115-d may resume or reenter an idle or sleep mode. Steps 330 and 335, along with other steps discussed, may or may not occur at the same time (e.g., there may be different delays associated with communications between the base station 105-b and each of UE 115-c and UE 115-d).

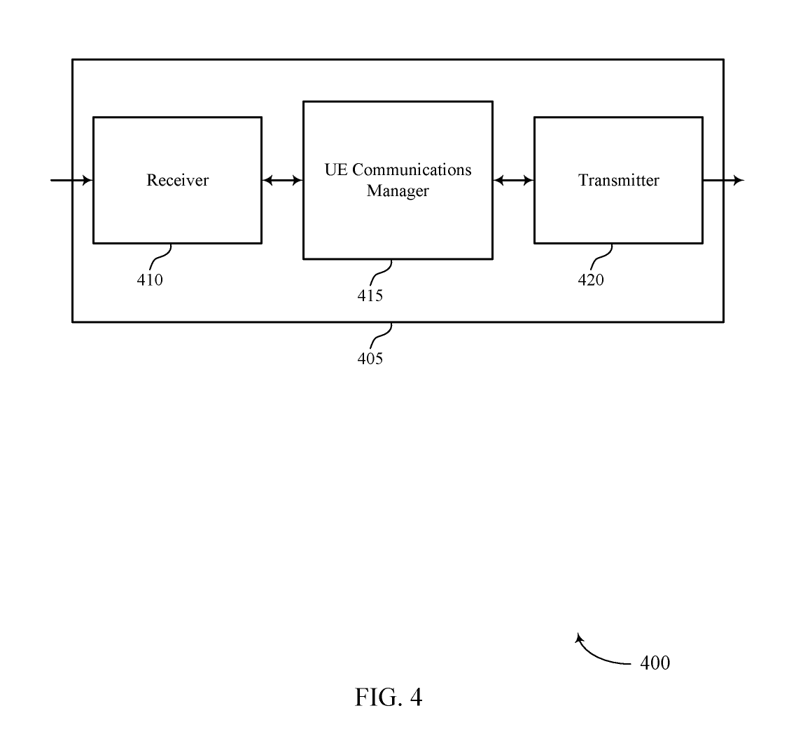

FIG. 4 shows a block diagram 400 of a wireless device 405 that supports improved paging techniques for multi-beam access systems in accordance with aspects of the present disclosure. Wireless device 405 may be an example of aspects of a user equipment (UE) 115 as described herein. Wireless device 405 may include receiver 410, UE communications manager 415, and transmitter 420. Wireless device 405 may also include a processor. Each of these components may be in communication with one another (e.g., via one or more buses).

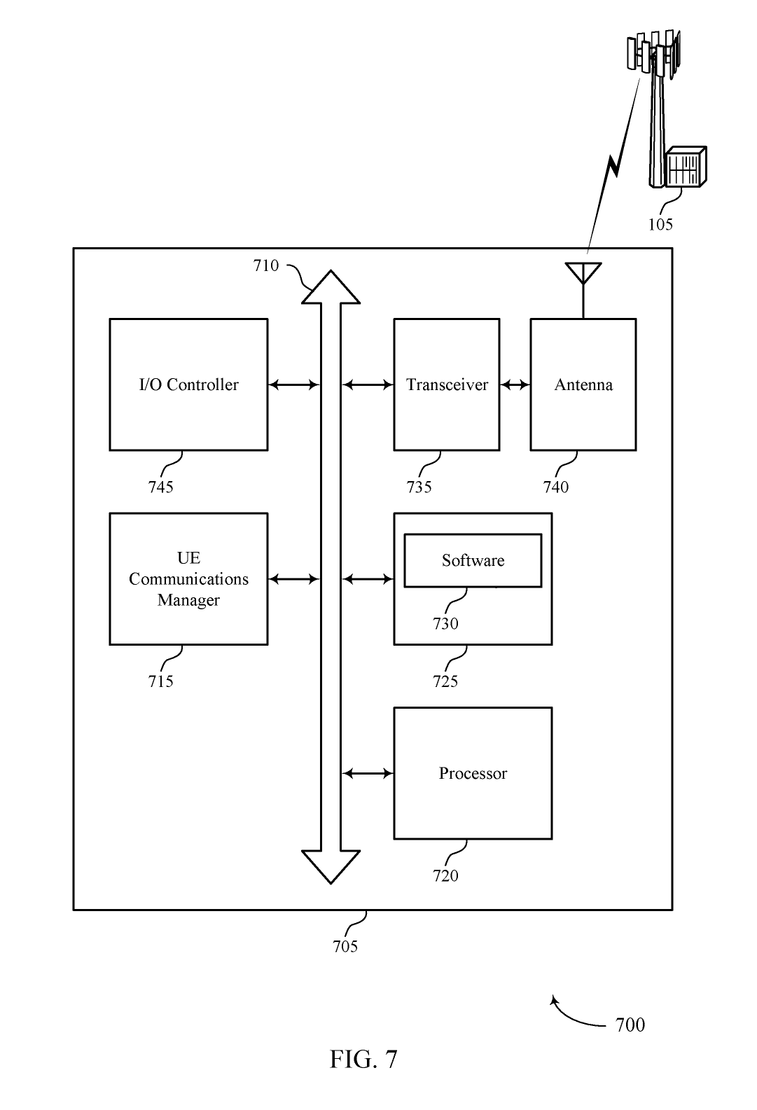

Receiver 410 may receive information such as packets, user data, or control information associated with various information channels (e.g., control channels, data channels, and information related to improved paging techniques for multi-beam access systems, etc.). Information may be passed on to other components of the device. Receiver 410 may be an example of aspects of the transceiver 735 described with reference to FIG. 7. Receiver 410 may utilize a single antenna or a set of antennas.

UE communications manager 415 may be an example of aspects of UE communications manager 715 described with reference to FIG. 7. UE communications manager 415 and/or at least some of its various sub-components may be implemented in hardware, software executed by a processor, firmware, or any combination thereof. If implemented in software executed by a processor, the functions of UE communications manager 415 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. UE communications manager 415 and/or at least some of its various sub-components may be physically located at various positions, including being distributed such that portions of functions are implemented at different physical locations by one or more physical devices. In some examples, UE communications manager 415 and/or at least some of its various sub-components may be a separate and distinct component in accordance with various aspects of the present disclosure. In other examples, UE communications manager 415 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE communications manager 415 may receive a compressed paging alert at a UE 115, transmit a connection request based on the received compressed paging alert, where the connection request includes a UE identifier and a paging response indication, and receive a connection response to the connection request based on the transmitted connection request.

Transmitter 420 may transmit signals generated by other components of the wireless device 405. In some examples, transmitter 420 may be collocated with a receiver 410 in a transceiver module. For example, transmitter 420 may be an example of aspects of transceiver 735 described with reference to FIG. 7. Transmitter 420 may utilize a single antenna or a set of antennas.

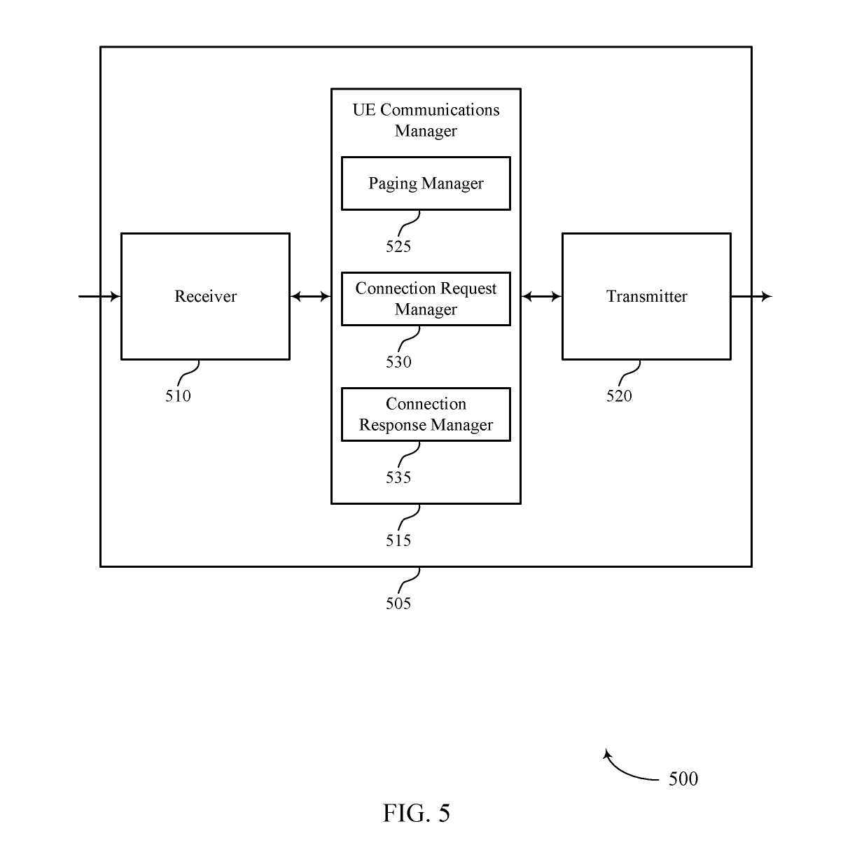

FIG. 5 shows a block diagram 500 of a wireless device 505 that supports improved paging techniques for multi-beam access systems in accordance with aspects of the present disclosure. Wireless device 505 may be an example of aspects of a wireless device 405 or a UE 115 as described with reference to FIG. 4. Wireless device 505 may include receiver 510, UE communications manager 515, and transmitter 520. Wireless device 505 may also include a processor. Each of these components may be in communication with one another (e.g., via one or more buses).

Receiver 510 may receive information such as packets, user data, or control information associated with various information channels (e.g., control channels, data channels, and information related to improved paging techniques for multi-beam access systems, etc.). Information may be passed on to other components of the device. Receiver 510 may be an example of aspects of the transceiver 735 described with reference to FIG. 7. Receiver 510 may utilize a single antenna or a set of antennas.

UE communications manager 515 may be an example of aspects of UE communications manager 715 described with reference to FIG. 7. UE communications manager 515 may also include paging manager 525, connection request manager 530, and connection response manager 535.

Paging manager 525 may receive a compression indication that indicates the compressed paging alert is compressed and receive a compressed paging alert at a UE. In some cases, the compressed paging alert is a broadcast paging alert and includes a paging index list.

Connection request manager 530 may include the paging response indication in the connection request based on the received compression indication, transmit a connection request based on the received compressed paging alert, where the connection request includes a UE identifier and a paging response indication, and transmit the connection request including the UE identifier, where the UE identifier is based on the received UE identification type. In some cases, the connection request includes a radio resource control (RRC) connection request message, or a first message of a random access procedure, or a third message of a random access procedure, or an RRC connection resume request message, or an RRC connection reactivation request message. In some cases, the UE identifier includes a system architecture evolution (SAE) temporary mobile subscriber identity (S-TMSI), an international mobile subscriber identity (IMSI), a 5G-GUTI, a 5G-S-TMSI, a PEI, a PUI, a SUCI, or a SUPI.

Connection response manager 535 may receive a connection response to the connection request based on the transmitted connection request. Transmitter 520 may transmit signals generated by other components of the wireless device 505. In some examples, transmitter 520 may be collocated with a receiver 510 in a transceiver module. For example, transmitter 520 may be an example of aspects of the transceiver 735 described with reference to FIG. 7. Transmitter 520 may utilize a single antenna or a set of antennas.

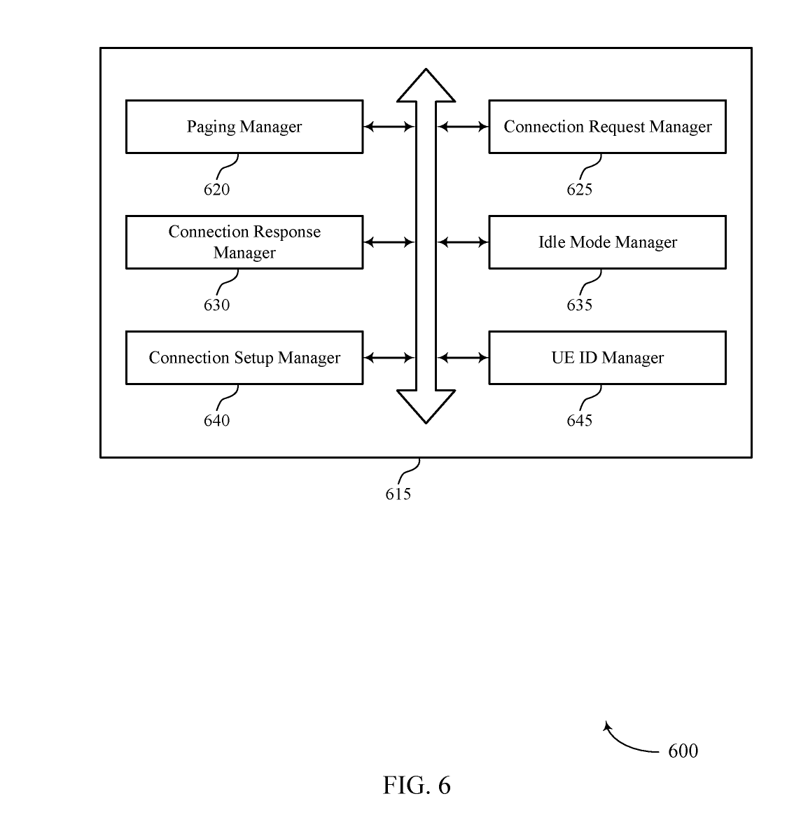

FIG. 6 shows a block diagram 600 of a UE communications manager 615 that supports improved paging techniques for multi-beam access systems in accordance with aspects of the present disclosure. UE communications manager 615 may be an example of aspects of a UE communications manager 415, a UE communications manager 515, or a UE communications manager 715 described with reference to FIGS. 4, 5, and 7. UE communications manager 615 may include paging manager 620, connection request manager 625, connection response manager 630, idle mode manager 635, connection setup manager 640, and UE ID manager 645. Each of these modules may communicate, directly or indirectly, with one another (e.g., via one or more buses).

Paging manager 620 may receive a compression indication that indicates the compressed paging alert is compressed and receive a compressed paging alert at a UE. In some cases, the compressed paging alert is a broadcast paging alert and includes a paging index list.

Connection request manager 625 may include the paging response indication in the connection request based on the received compression indication, transmit a connection request based on the received compressed paging alert, where the connection request includes a UE identifier and a paging response indication, and transmit the connection request including the UE identifier, where the UE identifier is based on the received UE identification type. In some cases, the connection request includes an RRC connection request message, or a first message of a random access procedure, or a third message of a random access procedure, or an RRC connection resume request message, or an RRC connection reactivation request message. In some cases, the UE identifier includes a system architecture evolution (SAE) temporary mobile subscriber identity (S-TMSI) or an international mobile subscriber identity (IMSI).

Connection response manager 630 may receive a connection response to the connection request based on the transmitted connection request. Idle mode manager 635 may enter an idle mode, suspend mode, or inactive mode based on the received connection response, where the connection response rejects the connection request. In some cases, the connection response includes an RRC connection reject message or an RRC connection release message.

Connection setup manager 640 may transmit a connection setup response message to the base station 105 based on the received connection response, where the connection response accepts the connection request. In some cases, the connection response includes an RRC connection setup message or an RRC connection resume message. In some cases, the connection setup response message includes an RRC connection setup complete message. UE ID manager 645 may receive a UE identification type.

FIG. 7 shows a diagram of a system 700 including a device 705 that supports improved paging techniques for multi-beam access systems in accordance with aspects of the present disclosure. Device 705 may be an example of or include the components of wireless device 405, wireless device 505, or a UE 115 as described above, e.g., with reference to FIGS. 4 and 5. Device 705 may include components for bi-directional voice and data communications including components for transmitting and receiving communications, including UE communications manager 715, processor 720, memory 725, software 730, transceiver 735, antenna 740, and I/O controller 745. These components may be in electronic communication via one or more buses (e.g., bus 710). Device 705 may communicate wirelessly with one or more base stations 105.

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting improved paging techniques for multi-beam access systems).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to support improved paging techniques for multi-beam access systems. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

I/O controller 745 may manage input and output signals for device 705. I/O controller 745 may also manage peripherals not integrated into device 705. In some cases, I/O controller 745 may represent a physical connection or port to an external peripheral. In some cases, I/O controller 745 may utilize an operating system such as iOS®, ANDROID®, MS-DOS®, MS-WINDOWS®, OS/2®, UNIX®, LINUX®, or another known operating system. In other cases, I/O controller 745 may represent or interact with a modem, a keyboard, a mouse, a touchscreen, or a similar device. In some cases, I/O controller 745 may be implemented as part of a processor. In some cases, a user may interact with device 705 via I/O controller 745 or via hardware components controlled by I/O controller 745.

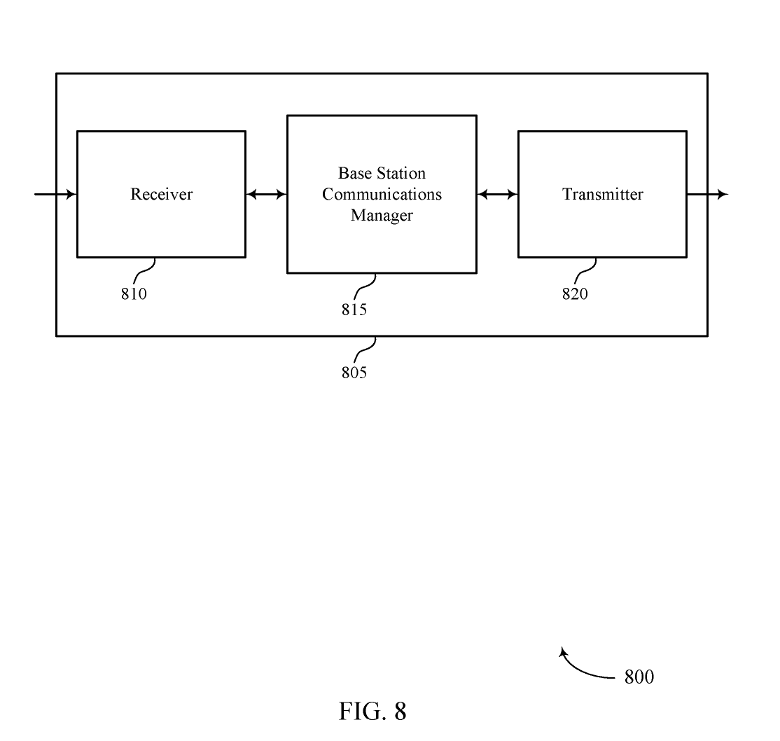

FIG. 8 shows a block diagram 800 of a wireless device 805 that supports improved paging techniques for multi-beam access systems in accordance with aspects of the present disclosure. Wireless device 805 may be an example of aspects of a base station 105 as described herein. Wireless device 805 may include receiver 810, base station communications manager 815, and transmitter 820. Wireless device 805 may also include a processor. Each of these components may be in communication with one another (e.g., via one or more buses).

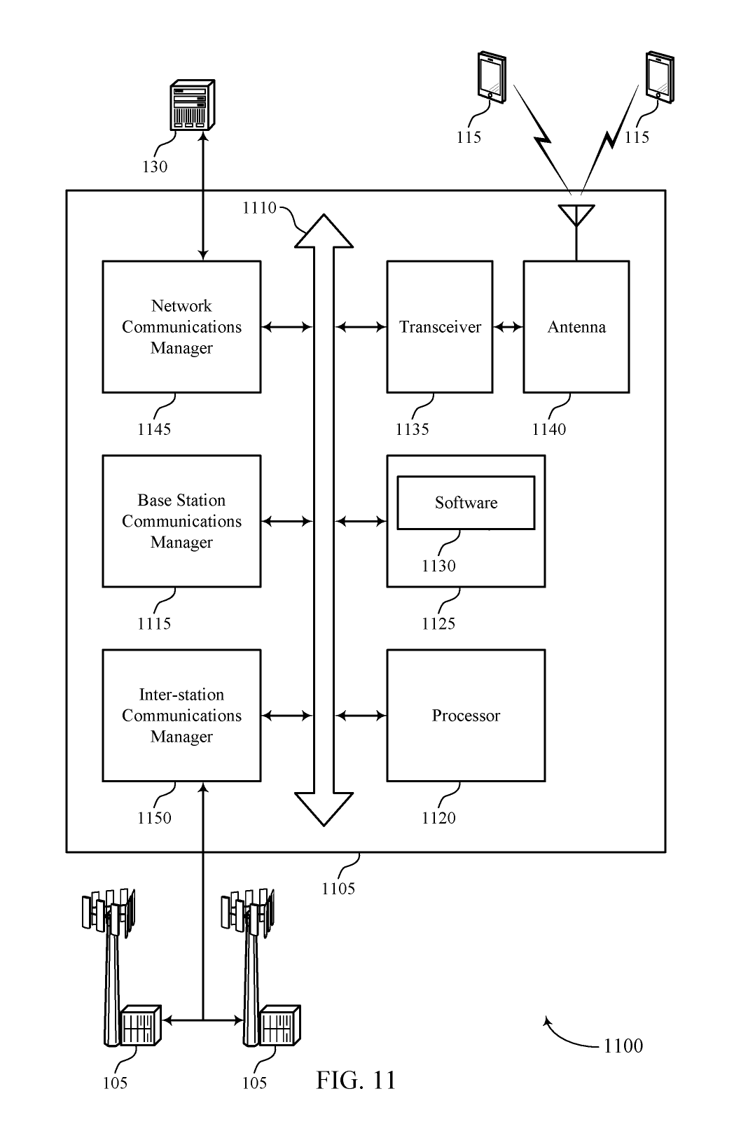

Receiver 810 may receive information such as packets, user data, or control information associated with various information channels (e.g., control channels, data channels, and information related to improved paging techniques for multi-beam access systems, etc.). Information may be passed on to other components of the device. Receiver 810 may be an example of aspects of the transceiver 1135 described with reference to FIG. 11. Receiver 810 may utilize a single antenna or a set of antennas.

Base station communications manager 815 may be an example of aspects of base station communications manager 1115 described with reference to FIG. 11. Base station communications manager 815 and/or at least some of its various sub-components may be implemented in hardware, software executed by a processor, firmware, or any combination thereof. If implemented in software executed by a processor, the functions of base station communications manager 815 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. Base station communications manager 815 and/or at least some of its various sub-components may be physically located at various positions, including being distributed such that portions of functions are implemented at different physical locations by one or more physical devices. In some examples, base station communications manager 815 and/or at least some of its various sub-components may be a separate and distinct component in accordance with various aspects of the present disclosure. In other examples, base station communications manager 815 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure. Base station communications manager 815 may receive a connection request from a UE, the connection request including a UE identifier and a paging response indication, compare the UE identifier with a paging identifier list, and transmit a connection response based on a result of the comparison.

Transmitter 820 may transmit signals generated by other components of the device. In some examples, transmitter 820 may be collocated with a receiver 810 in a transceiver module. For example, transmitter 820 may be an example of aspects of the transceiver 1135 described with reference to FIG. 11. Transmitter 820 may utilize a single antenna or a set of antennas.

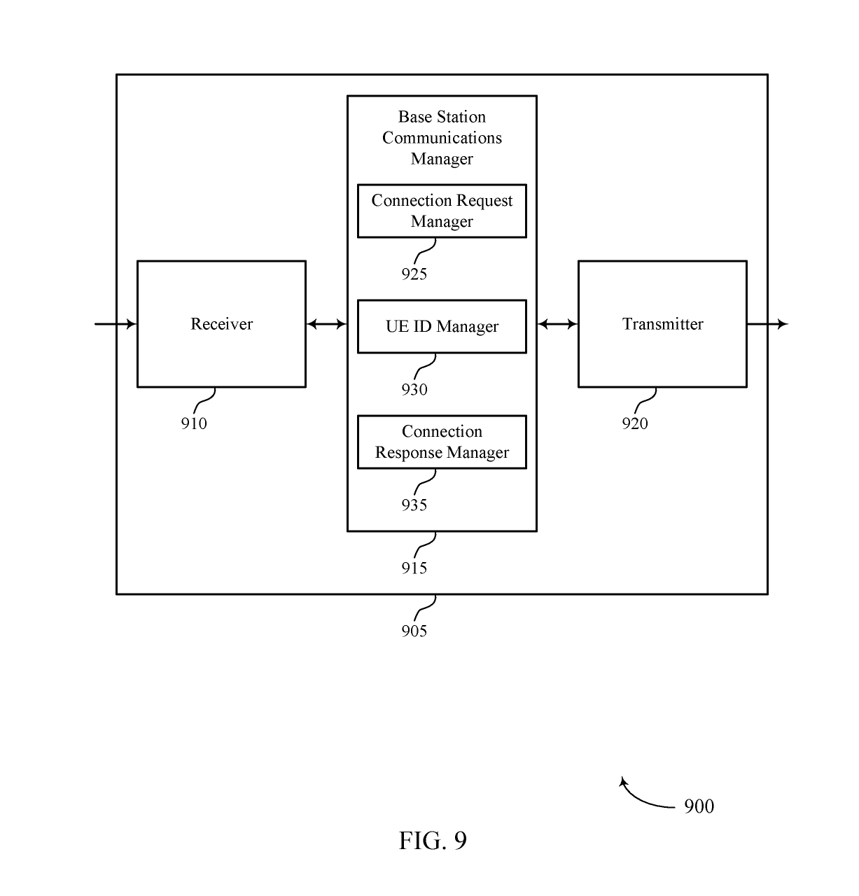

FIG. 9 shows a block diagram 900 of a wireless device 905 that supports improved paging techniques for multi-beam access systems in accordance with aspects of the present disclosure. Wireless device 905 may be an example of aspects of a wireless device 805 or a base station 105 as described with reference to FIG. 8. Wireless device 905 may include receiver 910, base station communications manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to improved paging techniques for multi-beam access systems, etc.). Information may be passed on to other components of the device. Receiver 910 may be an example of aspects of the transceiver 1135 described with reference to FIG. 11. Receiver 910 may utilize a single antenna or a set of antennas.

Base station communications manager 915 may be an example of aspects of base station communications manager 1115 described with reference to FIG. 11. Base station communications manager 915 may also include connection request manager 925, UE ID manager 930, and connection response manager 935.

Connection request manager 925 may receive a connection request from a UE, the connection request including a UE identifier and a paging response indication. In some cases, the received connection request includes an RRC connection request message, or a first message of a random access procedure, or a third message of a random access procedure, or an RRC connection resume request message, or an RRC connection reactivation request message. In some cases, the UE identifier includes a system architecture evolution (SAE) temporary mobile subscriber identity (S-TMSI) or an international mobile subscriber identity (IMSI). UE ID manager 930 may compare the UE identifier with a paging identifier list.

Connection response manager 935 may transmit a connection response based on a result of the comparison, transmit the connection response to the UE 115 based on the determination, where the connection response rejects the connection request, and transmit the connection response to the UE 115 based on the determination, where the connection response accepts the connection request. In some cases, the connection response includes an RRC connection reject message or an RRC connection release message. In some cases, the connection response includes an RRC connection setup message or an RRC connection resume message.

Transmitter 920 may transmit signals generated by other components of the device. In some examples, transmitter 920 may be collocated with a receiver 910 in a transceiver module. For example, transmitter 920 may be an example of aspects of the transceiver 1135 described with reference to FIG. 11. Transmitter 920 may utilize a single antenna or a set of antennas.

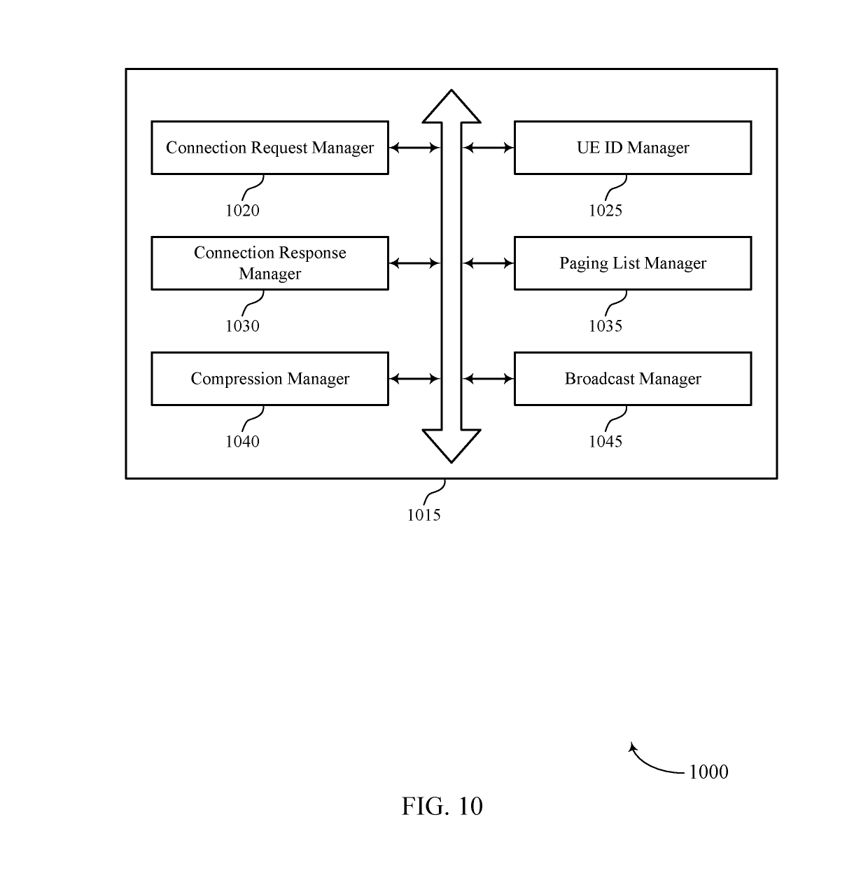

FIG. 10 shows a block diagram 1000 of a base station communications manager 1015 that supports improved paging techniques for multi-beam access systems in accordance with aspects of the present disclosure. Base station communications manager 1015 may be an example of aspects of base station communications manager 1115 described with reference to FIGS. 8, 9, and 11. Base station communications manager 1015 may include connection request manager 1020, UE ID manager 1025, connection response manager 1030, paging list manager 1035, compression manager 1040, and broadcast manager 1045. Each of these modules may communicate, directly or indirectly, with one another (e.g., via one or more buses).

Connection request manager 1020 may receive a connection request from a UE, the connection request including a UE identifier and a paging response indication. In some cases, the received connection request includes an RRC connection request message, or a first message of a random access procedure, or a third message of a random access procedure, or an RRC connection resume request message, or an RRC connection reactivation request message. In some cases, the UE identifier includes a system architecture evolution (SAE) temporary mobile subscriber identity (S-TMSI), an international mobile subscriber identity (IMSI), a 5G-GUTI, a 5G-S-TMSI, a PEI, a PUI, a SUCI, or a SUPI. UE ID manager 1025 may compare the UE identifier with a paging identifier list.

Connection response manager 1030 may transmit a connection response based on a result of the comparison, transmit the connection response to the UE 115 based on the determination, where the connection response rejects the connection request, and transmit the connection response to the UE 115 based on the determination, where the connection response accepts the connection request. In some cases, the connection response includes an RRC connection reject message or an RRC connection release message. In some cases, the connection response includes an RRC connection setup message or an RRC connection resume message.

Paging list manager 1035 may determine the paging identifier list, the paging identifier list including one or more UE identifiers, determine that the received UE identifier does not correspond to any entries of the paging identifier list, and determine that the UE identifier matches one or more entries of the paging identifier list.

Compression manager 1040 may compile a paging index list based on the determined paging identifier list and transmit a compression indication that indicates a paging index list was compressed.

Broadcast manager 1045 may broadcast the paging index list, where the connection request is received based on the broadcast paging index list, broadcast a compressed paging message, where the connection request from the UE 115 is received in response to the compressed paging message, and broadcast the paging index list based on the transmitted compression indication. In some cases, the compressed paging message includes a paging index list. In some cases, the compressed paging message further includes broadcasting a UE identifier type for one or more UEs of the paging index list.

FIG. 11 shows a diagram of a system 1100 including a device 1105 that supports improved paging techniques for multi-beam access systems in accordance with aspects of the present disclosure. Device 1105 may be an example of or include the components of base station 105 as described above, e.g., with reference to FIG. 1. Device 1105 may include components for bi-directional voice and data communications including components for transmitting and receiving communications, including base station communications manager 1115, processor 1120, memory 1125, software 1130, transceiver 1135, antenna 1140, network communications manager 1145, and inter-station communications manager 1150. These components may be in electronic communication via one or more buses (e.g., bus 1110). Device 1105 may communicate wirelessly with one or more UEs 115.

Processor 1120 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting improved paging techniques for multi-beam access systems).

Memory 1125 may include RAM and ROM. The memory 1125 may store computer-readable, computer-executable software 1130 including instructions that, when executed, cause the processor to perform various functions described herein. In some cases, the memory 1125 may contain, among other things, a BIOS which may control basic hardware or software operation such as the interaction with peripheral components or devices.

Software 1130 may include code to implement aspects of the present disclosure, including code to support improved paging techniques for multi-beam access systems. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

Network communications manager 1145 may manage communications with the core network (e.g., via one or more wired backhaul links). For example, the network communications manager 1145 may manage the transfer of data communications for client devices, such as one or more UEs 115.

Inter-station communications manager 1150 may manage communications with other base station 105, and may include a controller or scheduler for controlling communications with UEs 115 in cooperation with other base stations 105. For example, the inter-station communications manager 1150 may coordinate scheduling for transmissions to UEs 115 for various interference mitigation techniques such as beamforming or joint transmission. In some examples, inter-station communications manager 1150 may provide an X2 interface within an Long Term Evolution (LTE)/LTE-A wireless communication network technology to provide communication between base stations 105.

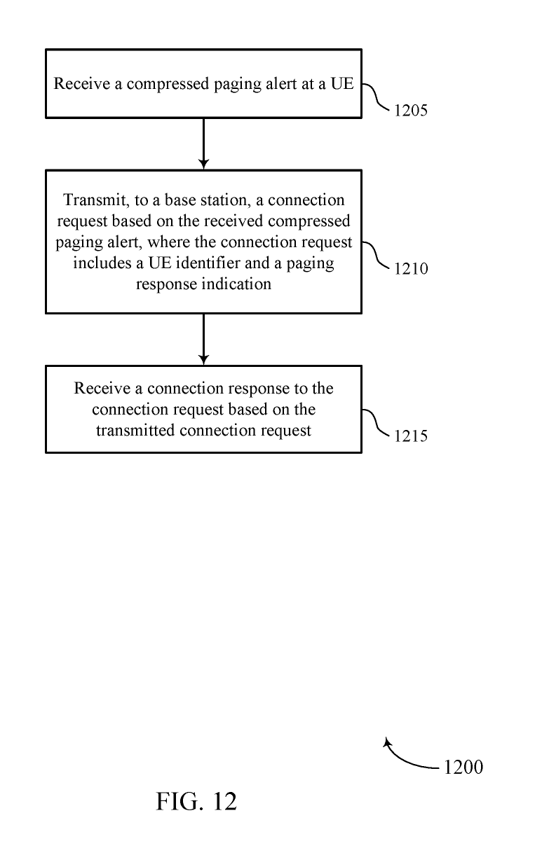

FIG. 12 shows a flowchart illustrating a method 1200 for improved paging techniques for multi-beam access systems in accordance with aspects of the present disclosure. The operations of method 1200 may be implemented by a UE 115 or its components as described herein. For example, the operations of method 1200 may be performed by UE communications manager 415, 515, 615, and 715 as described with reference to FIGS. 4 through 7. In some examples, a UE 115 may execute a set of codes to control the functional elements of the device to perform the functions described below. Additionally or alternatively, the UE 115 may perform aspects of the functions described below using special-purpose hardware.

At block 1205, the UE 115 may receive a compressed paging alert. The operations of block 1205 may be performed according to the methods described herein. In certain examples, aspects of the operations of block 1205 may be performed by a paging manager 525 and 620 as described with reference to FIGS. 4 through 7.

At block 1210, the UE 115 may transmit a connection request based at least in part on the received compressed paging alert, wherein the connection request includes a UE identifier and a paging response indication. The operations of block 1210 may be performed according to the methods described herein. In certain examples, aspects of the operations of block 1210 may be performed by a connection request manager 530 and 625 as described with reference to FIGS. 4 through 7.

At block 1215, the UE 115 may receive a connection response to the connection request based at least in part on the transmitted connection request. The operations of block 1215 may be performed according to the methods described herein. In certain examples, aspects of the operations of block 1215 may be performed by a connection response manager 535 and 630 as described with reference to FIGS. 4 through 7.

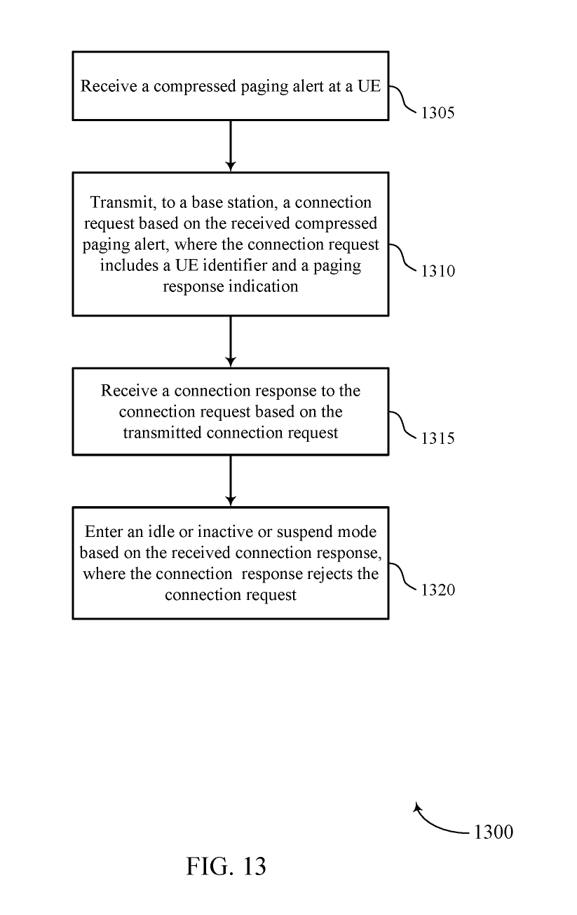

FIG. 13 shows a flowchart illustrating a method 1300 for improved paging techniques for multi-beam access systems in accordance with aspects of the present disclosure. The operations of method 1300 may be implemented by a UE 115 or its components as described herein. For example, the operations of method 1300 may be performed by a UE communications manager 415, 515, 615, and 715 as described with reference to FIGS. 4 through 7. In some examples, a UE 115 may execute a set of codes to control the functional elements of the device to perform the functions described below. Additionally or alternatively, the UE 115 may perform aspects of the functions described below using special-purpose hardware.

At block 1305, the UE 115 may receive a compressed paging alert. The operations of block 1305 may be performed according to the methods described herein. In certain examples, aspects of the operations of block 1305 may be performed by a paging manager 525 and 620 as described with reference to FIGS. 4 through 7.

At block 1310, the UE 115 may transmit a connection request based at least in part on the received compressed paging alert, wherein the connection request includes a UE identifier and a paging response indication. The operations of block 1310 may be performed according to the methods described herein. In certain examples, aspects of the operations of block 1310 may be performed by a connection request manager 530 and 625 as described with reference to FIGS. 4 through 7.

At block 1315, the UE 115 may receive a connection response to the connection request based at least in part on the transmitted connection request. The operations of block 1315 may be performed according to the methods described herein. In certain examples, aspects of the operations of block 1315 may be performed by a connection response manager 535 and 630 as described with reference to FIGS. 4 through 7.

At block 1320, the UE 115 may enter an idle mode, suspend mode, or inactive mode based at least in part on the received connection response, wherein the connection response rejects the connection request. The operations of block 1320 may be performed according to the methods described herein. In certain examples, aspects of the operations of block 1320 may be performed by an idle mode manager as described with reference to FIGS. 4 through 7.

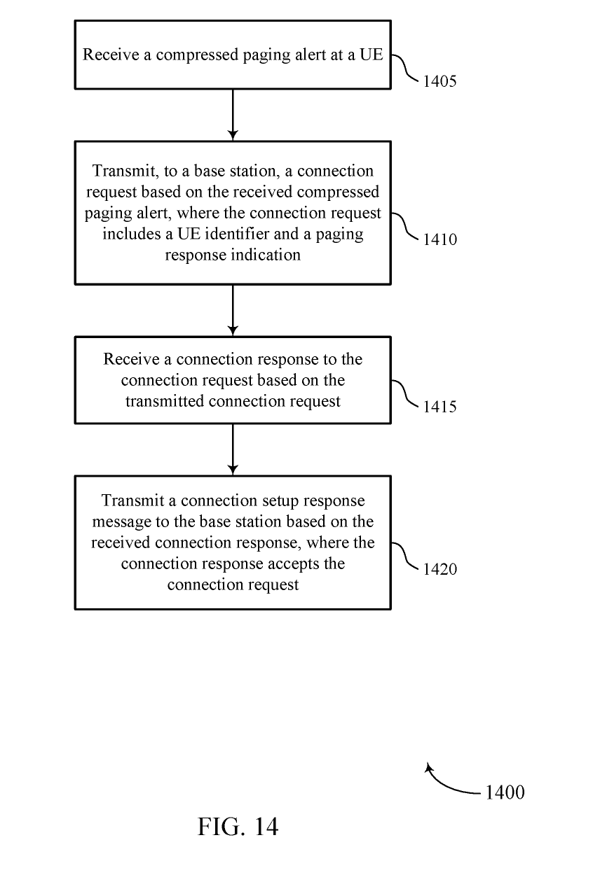

FIG. 14 shows a flowchart illustrating a method 1400 for improved paging techniques for multi-beam access systems in accordance with aspects of the present disclosure. The operations of method 1400 may be implemented by a UE 115 or its components as described herein. For example, the operations of method 1400 may be performed by a UE communications manager 415, 515, 615, and 715 as described with reference to FIGS. 4 through 7. In some examples, a UE 115 may execute a set of codes to control the functional elements of the device to perform the functions described below. Additionally or alternatively, the UE 115 may perform aspects of the functions described below using special-purpose hardware.

At block 1405, the UE 115 may receive a compressed paging alert. The operations of block 1405 may be performed according to the methods described herein. In certain examples, aspects of the operations of block 1405 may be performed by a paging manager 525 and 620 as described with reference to FIGS. 4 through 7.

At block 1410, the UE 115 may transmit a connection request based at least in part on the received compressed paging alert, wherein the connection request includes a UE identifier and a paging response indication. The operations of block 1410 may be performed according to the methods described herein. In certain examples, aspects of the operations of block 1410 may be performed by a connection request manager 530 and 625 as described with reference to FIGS. 4 through 7.

At block 1415, the UE 115 may receive a connection response to the connection request based at least in part on the transmitted connection request. The operations of block 1415 may be performed according to the methods described herein. In certain examples, aspects of the operations of block 1415 may be performed by a connection response manager 535 and 630 as described with reference to FIGS. 4 through 7.

At block 1420, the UE 115 may transmit a connection setup response message to the base station 105 based at least in part on the received connection response, wherein the connection response accepts the connection request. The operations of block 1420 may be performed according to the methods described herein. In certain examples, aspects of the operations of block 1420 may be performed by a connection setup manager 640 as described with reference to FIGS. 4 through 7.

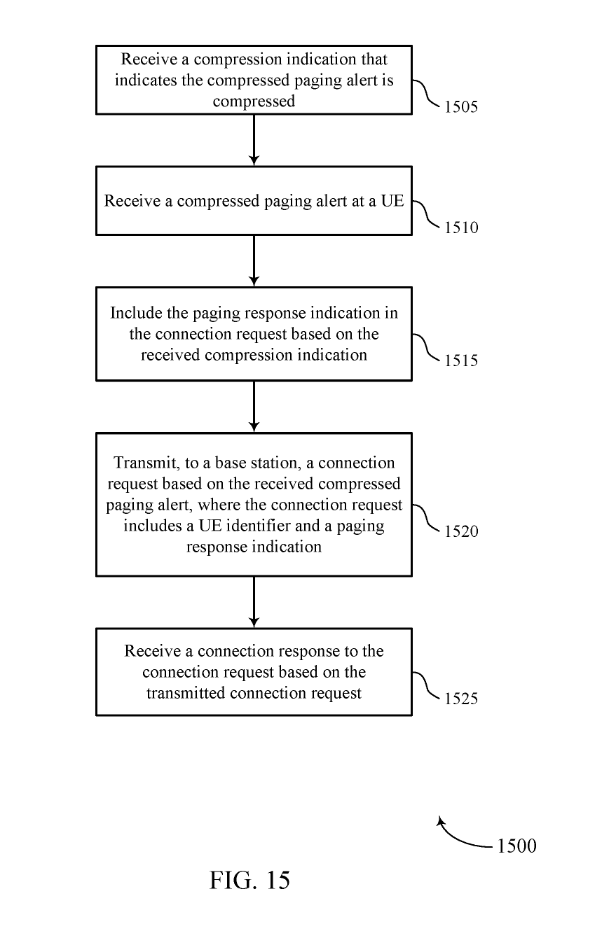

FIG. 15 shows a flowchart illustrating a method 1500 for improved paging techniques for multi-beam access systems in accordance with aspects of the present disclosure. The operations of method 1500 may be implemented by a UE 115 or its components as described herein. For example, the operations of method 1500 may be performed by UE communications manager 415, 515, 615, and 715 as described with reference to FIGS. 4 through 7. In some examples, a UE 115 may execute a set of codes to control the functional elements of the device to perform the functions described below. Additionally or alternatively, the UE 115 may perform aspects of the functions described below using special-purpose hardware.

At block 1505, the UE 115 may receive a compression indication that indicates the compressed paging alert is compressed. The operations of block 1505 may be performed according to the methods described herein. In certain examples, aspects of the operations of block 1505 may be performed by a paging manager 525 and 620 as described with reference to FIGS. 4 through 7.

At block 1510, the UE 115 may receive a compressed paging alert. The operations of block 1510 may be performed according to the methods described herein. In certain examples, aspects of the operations of block 1510 may be performed by a paging manager 525 and 620 as described with reference to FIGS. 4 through 7.

At block 1515, the UE 115 may include a paging response indication in a connection request based at least in part on the received compression indication. The operations of block 1515 may be performed according to the methods described herein. In certain examples, aspects of the operations of block 1515 may be performed by a connection request manager 530 and 625 as described with reference to FIGS. 4 through 7.

At block 1520, the UE 115 may transmit the connection request based at least in part on the received compressed paging alert, wherein the connection request includes a UE identifier and the paging response indication. The operations of block 1520 may be performed according to the methods described herein. In certain examples, aspects of the operations of block 1520 may be performed by a connection request manager 530 and 625 as described with reference to FIGS. 4 through 7.

At block 1525, the UE 115 may receive a connection response to the connection request based at least in part on the transmitted connection request. The operations of block 1525 may be performed according to the methods described herein. In certain examples, aspects of the operations of block 1525 may be performed by a connection response manager 535 and 630 as described with reference to FIGS. 4 through 7.

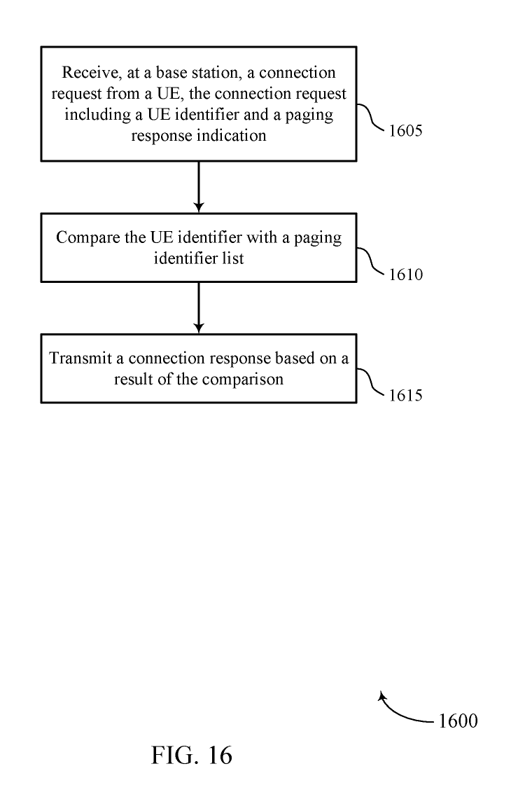

FIG. 16 shows a flowchart illustrating a method 1600 for improved paging techniques for multi-beam access systems in accordance with aspects of the present disclosure. The operations of method 1600 may be implemented by a base station 105 or its components as described herein. For example, the operations of method 1600 may be performed by base station communications manager 815, 915, 1015, and 1115 as described with reference to FIGS. 8 through 11. In some examples, a base station 105 may execute a set of codes to control the functional elements of the device to perform the functions described below. Additionally or alternatively, the base station 105 may perform aspects of the functions described below using special-purpose hardware.

At block 1605, the base station 105 may receive a connection request from a user equipment (UE) 115, the connection request including a UE identifier and a paging response indication. The operations of block 1605 may be performed according to the methods described herein. In certain examples, aspects of the operations of block 1605 may be performed by a connection request manager 925 and 1020 as described with reference to FIGS. 8 through 11.

At block 1610, the base station 105 may compare the UE identifier with a paging identifier list. The operations of block 1610 may be performed according to the methods described herein. In certain examples, aspects of the operations of block 1610 may be performed by a UE ID manager 930 and 1025 as described with reference to FIGS. 8 through 11.

At block 1615, the base station 105 may transmit a connection response based at least in part on a result of the comparison. The operations of block 1615 may be performed according to the methods described herein. In certain examples, aspects of the operations of block 1615 may be performed by a connection response manager 935 and 1030 as described with reference to FIGS. 8 through 11.

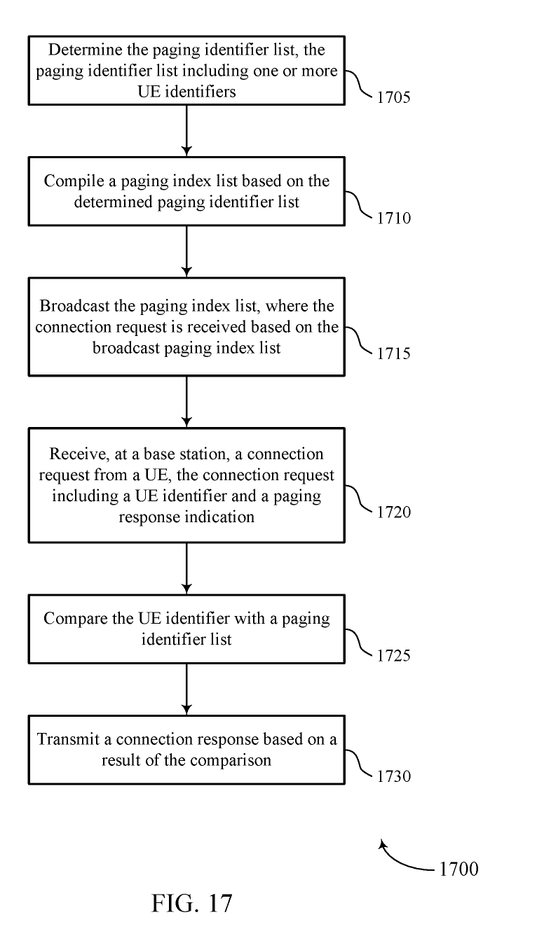

FIG. 17 shows a flowchart illustrating a method 1700 for improved paging techniques for multi-beam access systems in accordance with aspects of the present disclosure. The operations of method 1700 may be implemented by a base station 105 or its components as described herein. For example, the operations of method 1700 may be performed by base station communications manager 815, 915, 1015, and 1115 as described with reference to FIGS. 8 through 11. In some examples, a base station 105 may execute a set of codes to control the functional elements of the device to perform the functions described below. Additionally or alternatively, the base station 105 may perform aspects of the functions described below using special-purpose hardware.

At block 1705, the base station 105 may determine a paging identifier list, the paging identifier list may include one or more UE identifiers. The operations of block 1705 may be performed according to the methods described herein. In certain examples, aspects of the operations of block 1705 may be performed by a paging list manager 1035 as described with reference to FIGS. 8 through 11.

At block 1710, the base station 105 may compile a paging index list based at least in part on the determined paging identifier list. The operations of block 1710 may be performed according to the methods described herein. In certain examples, aspects of the operations of block 1710 may be performed by a compression manager 1040 as described with reference to FIGS. 8 through 11.

At block 1715, the base station 105 may broadcast the paging index list, wherein the connection request is received based at least in part on the broadcast paging index list. The operations of block 1715 may be performed according to the methods described herein. In certain examples, aspects of the operations of block 1715 may be performed by a broadcast manager 1045 as described with reference to FIGS. 8 through 11.

At block 1720, the base station 105 may receive a connection request from a UE, the connection request including a UE identifier and a paging response indication. The operations of block 1720 may be performed according to the methods described herein. In certain examples, aspects of the operations of block 1720 may be performed by a connection request manager 925 and 1020 as described with reference to FIGS. 8 through 11.

At block 1725, the base station 105 may compare the UE identifier with a paging identifier list. The operations of block 1725 may be performed according to the methods described herein. In certain examples, aspects of the operations of block 1725 may be performed by a UE ID manager 930 and 1025 as described with reference to FIGS. 8 through 11.

At block 1730, the base station 105 may transmit a connection response based at least in part on a result of the comparison. The operations of block 1730 may be performed according to the methods described herein. In certain examples, aspects of the operations of block 1730 may be performed by a connection response manager 935 and 1030 as described with reference to FIGS. 8 through 11.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of eNBs provide coverage for various geographical regions. For example, each eNB, next generation NodeB (gNB), or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), gNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving a compressed paging alert at a user equipment (UE);
transmitting, to a base station, a connection request based at least in part on the received compressed paging alert, wherein the connection request includes a UE identifier and a paging response indication; and
receiving a connection response to the connection request based at least in part on the transmitted connection request.

2. The method of claim 1, further comprising:
receiving a compression indication that indicates the compressed paging alert is compressed; and
including the paging response indication in the connection request based at least in part on the received compression indication.

3. The method of claim 1, further comprising:
entering an idle mode, suspend mode, or inactive mode based at least in part on the received connection response, wherein the connection response rejects the connection request.

4. The method of claim 3, wherein:
the connection response comprises a radio resource control (RRC) connection reject message or an RRC connection release message.

5. The method of claim 1, further comprising:
transmitting a connection setup response message to the base station based at least in part on the received connection response, wherein the connection response accepts the connection request.

6. The method of claim 5, wherein:
the connection response comprises a radio resource control (RRC) connection setup message or an RRC connection resume message; and
the connection setup response message comprises an RRC connection setup complete message.

7. The method of claim 1, wherein:
the compressed paging alert is a broadcast paging alert and includes a paging index list.

8. The method of claim 1, wherein:
the connection request comprises a radio resource control (RRC) connection request message, or a first message of a random access procedure, or a third message of a random access procedure, or an RRC connection resume request message, or an RRC connection reactivation request message.

9. The method of claim 1, wherein:
the UE identifier comprises a system architecture evolution (SAE) temporary mobile subscriber identity (S-TMSI), or an international mobile subscriber identity (IMSI), or a 5G globally unique temporary identifier (5G-GUTI), or a 5G S-temporary mobile subscription identifier (5G-S-TMSI), or a permanent equipment identifier (PEI), or a public UE identifier (PUI), or a subscription concealed identifier (SUCI), or a subscription permanent identifier (SUPI).

10. The method of claim 1, further comprising:
receiving a UE identification type; and
transmitting the connection request including the UE identifier, wherein the UE identifier is based at least in part on the received UE identification type.

11. A method for wireless communication, comprising:
receiving, at a base station, a connection request from a user equipment (UE), the connection request including a UE identifier and a paging response indication;
comparing the UE identifier with a paging identifier list; and
transmitting a connection response based at least in part on a result of the comparison.

12. The method of claim 11, further comprising:
determining that the received UE identifier does not correspond to any entries of the paging identifier list; and
transmitting the connection response to the UE based at least in part on the determination, wherein the connection response rejects the connection request.

13. The method of claim 12, wherein:
the connection response comprises a radio resource control (RRC) connection reject message or an RRC connection release message.

14. The method of claim 11, further comprising:
determining that the UE identifier matches one or more entries of the paging identifier list; and
transmitting the connection response to the UE based at least in part on the determination, wherein the connection response accepts the connection request.

15. The method of claim 14, wherein:
the connection response comprises a radio resource control (RRC) connection setup message or an RRC connection resume message.

16. The method of claim 11, further comprising:
determining the paging identifier list, the paging identifier list including one or more UE identifiers;
compiling a paging index list based at least in part on the determined paging identifier list; and
broadcasting the paging index list, wherein the connection request is received based at least in part on the broadcast paging index list.

17. The method of claim 11, further comprising:
broadcasting a compressed paging message, wherein the connection request from the UE is received in response to the compressed paging message.

18. The method of claim 11, further comprising:
transmitting a compression indication that indicates a paging index list was compressed; and
broadcasting the paging index list based at least in part on the transmitted compression indication.

19. The method of claim 11, wherein:
the received connection request comprises a radio resource control (RRC) connection request message, or a first message of a random access procedure, or a third message of a random access procedure, or an RRC connection resume request message, or an RRC connection reactivation request message.

20. An apparatus for wireless communication, comprising:
a processor;
memory in electronic communication with the processor; and
instructions stored in the memory and operable, when executed by the processor, to cause the apparatus to:
receive a compressed paging alert at a user equipment (UE);
transmit, to a base station, a connection request based at least in part on the received compressed paging alert, wherein the connection request includes a UE identifier and a paging response indication; and
receive a connection response to the connection request based at least in part on the transmitted connection request.

21. The apparatus of claim 20, wherein the instructions, when executed by the processor, further cause the apparatus to:
receive a compression indication that indicates the compressed paging alert is compressed; and
include the paging response indication in the connection request based at least in part on the received compression indication.

22. The apparatus of claim 20, wherein the instructions, when executed by the processor, further cause the apparatus to:
enter an idle mode, suspend mode, or inactive mode based at least in part on the received connection response, wherein the connection response rejects the connection request.

23. The apparatus of claim 22, wherein:
the connection response comprises a radio resource control (RRC) connection reject message or an RRC connection release message.

24. The apparatus of claim 20, wherein the instructions, when executed by the processor, further cause the apparatus to:
transmit a connection setup response message to the base station based at least in part on the received connection response, wherein the connection response accepts the connection request.

25. The apparatus of claim 24, wherein:
the connection response comprises a radio resource control (RRC) connection setup message or an RRC connection resume message; and
the connection setup response message comprises an RRC connection setup complete message.

26. The apparatus of claim 20, wherein:
the connection request comprises a radio resource control (RRC) connection request message, or a first message of a random access procedure, or a third message of a random access procedure, or an RRC connection resume request message, or an RRC connection reactivation request message.

27. An apparatus for wireless communication, comprising:
a processor;
memory in electronic communication with the processor; and
instructions stored in the memory and operable, when executed by the processor, to cause the apparatus to:
receive, at a base station, a connection request from a user equipment (UE), the connection request including a UE identifier and a paging response indication;
compare the UE identifier with a paging identifier list; and
transmit a connection response based at least in part on a result of the comparison.

28. The apparatus of claim 27, wherein the instructions, when executed by the processor, further cause the apparatus to:
determine that the received UE identifier does not correspond to any entries of the paging identifier list; and
transmit the connection response to the UE based at least in part on the determination, wherein the connection response rejects the connection request.

29. The apparatus of claim 27, wherein the instructions, when executed by the processor, further cause the apparatus to:
determine that the UE identifier matches one or more entries of the paging identifier list; and
transmit the connection response to the UE based at least in part on the determination, wherein the connection response accepts the connection request.

30. The apparatus of claim 27, wherein the instructions, when executed by the processor, further cause the apparatus to:
determine the paging identifier list, the paging identifier list including one or more UE identifiers;
compile a paging index list based at least in part on the determined paging identifier list; and
broadcast the paging index list, wherein the connection request is received based at least in part on the broadcast paging index list.
